(19) United States
(12) Patent Application Publication
(10) Pub. No.: US 2020/0026316 A1
(43) Pub. Date: Jan. 23, 2020

(54) IMAGING APPARATUS, IMAGING SYSTEM, AND IMAGING METHOD

(71) Applicants: NATIONAL INSTITUTE OF ADVANCED INDUSTRIAL SCIENCE AND TECHNOLOGY, Tokyo (JP); NIKON CORPORATION, Tokyo (JP)

(72) Inventors: Yuzuru IKEHARA, Tsukuba-shi (JP); Sanae IKEHARA, Tsukuba-shi (JP); Masahiro TOTSU, Tokyo (JP); Takuya YANAGAWA, Tokyo (JP); Zhen LIU, Tokyo (JP)

(73) Assignees: NATIONAL INSTITUTE OF ADVANCED INDUSTRIAL SCIENCE AND TECHNOLOGY, Tokyo (JP); NIKON CORPORATION, Tokyo (JP)

(21) Appl. No.: 16/545,497

(22) Filed: Aug. 20, 2019

Related U.S. Application Data
(63) Continuation of application No. PCT/JP2017/006346, filed on Feb. 21, 2017.

(51) Int. Cl. G05D 25/02; H05B 39/04; G06T 7/00

(52) U.S. Cl. CPC G05D 25/02; H05B 39/041; G06T 2207/30004; G06T 2207/10048; G06T 2207/20212; G06T 7/0012

(57) ABSTRACT

In order to discriminate sites in a sample effectively, an imaging apparatus according to an embodiment is provided with: a light detector for detecting light radiated from a sample irradiated with first-wavelength infrared light and second-wavelength infrared light from a light source; and a controller for adjusting the intensity of the first-wavelength infrared light or the intensity of the second-wavelength infrared light, and generating an image of the sample based on a detection result obtained by irradiating the sample with the first-wavelength infrared light and the second-wavelength infrared light simultaneously.

### CROSS REFERENCE TO RELATED APPLICATIONS

This is a Continuation of PCT International Application PCT/JP2017/006346 filed on Feb. 21, 2017. The entire contents of the above document are hereby incorporated by reference into the present application.

### BACKGROUND

### Technical Field

The present invention relates to an imaging apparatus, an imaging system, and an imaging method.

### Background Art

For example, in the field of medicine, JP 2004-237051 A discloses that an image of tissues (such as a blood vessel) of a living organism is captured, and the captured image is utilized for various diagnoses, examinations, observation and the like.

### SUMMARY

According to an embodiment, there is provided an imaging apparatus including: a light detector configured to detect light radiated from a sample irradiated with first-wavelength infrared light and second-wavelength infrared light from a light source; and a controller configured to adjust an intensity of the first-wavelength infrared light or an intensity of the second-wavelength infrared light, and configured to generate an image of the sample based on a detection result obtained by irradiating the sample with the first-wavelength infrared light and the second-wavelength infrared light simultaneously.

According to an embodiment, there is provided an imaging apparatus including: a light detector configured to detect light radiated from a sample due to, while irradiating the sample with first-wavelength infrared light, irradiation of the sample with second-wavelength infrared light with an intensity thereof adjusted with respect to the first-wavelength infrared light; and a controller configured to generate an image of the sample based on a detection result obtained by the light detector.

According to an embodiment, there is provided an imaging system including the imaging apparatus and a display apparatus configured to display the generated image.

According to an embodiment, there is provided an imaging method including: a light detector detecting light radiated from a sample irradiated with first-wavelength infrared light and second-wavelength infrared light from a light source; and a control apparatus adjusting an intensity of the first-wavelength infrared light or an intensity of the second wavelength infrared light, and generating an image of the sample based on a detection result obtained by irradiating the sample with the first-wavelength infrared light and the second-wavelength infrared light simultaneously.

### BRIEF DESCRIPTION OF THE DRAWINGS

FIGS. 1A and 1B are diagrams illustrating a configuration example of an imaging system 1 according to a first embodiment;

FIGS. 2A, 2B, 2C, and 2D illustrate the details of the peripheries of illumination units 3 according to the present embodiment;

FIGS. 3A and 3B illustrate movement of an imaging unit 4 of an imaging apparatus 10 included in the imaging system 1 according to the first embodiment;

FIGS. 4A and 4B illustrate the details of a calibration reference 5 and a switcher 6 according to the present embodiment;

FIGS. 5A, 5B, and 5C illustrate a container (which may also be referred to as a housing) 8 of the imaging apparatus 10 according to the present embodiment;

FIG. 6 is a diagram of the absorbance (absorbance curves, spectral distributions, and optical spectra) by wavelength (infrared light region) relating to water and oil (for example, vegetable oil) according to the present embodiment;

FIG. 7 is a diagram for theoretically describing a grayscale value raising effect due to simultaneous irradiation with infrared light of two wavelengths according to the present embodiment;

FIGS. 8A, 8B, and 8C show actual images (detection results) illustrating the grayscale value raising effect of simultaneous irradiation with infrared light of two wavelengths according to the present embodiment;

FIGS. 9A, 9B, and 9C are schematic drawings of the images of FIGS. 8A, 8B, and 8C, depicted to facilitate an understanding of the images shown in FIGS. 8A, 8B, and 8C;

FIG. 10 is a diagram of the absorbance (absorbance curves, spectral distributions, and optical spectra) by wavelength (infrared light region) relating to water, heavy water, and oil (for example, vegetable oil) according to the present embodiment;

FIGS. 11A, 11B, and 11C illustrate examples of combinations of wavelengths with which it is possible to discriminate water, heavy water, and oil according to the present embodiment;

FIGS. 12A, 12B, and 12C are schematic drawings of the images of FIGS. 11A, 11B, and 11C, depicted to facilitate an understanding of the images shown in FIGS. 11A, 11B, and 11B;

FIGS. 13A, 13B, and 13C illustrate examples of combinations of wavelengths with which it is possible to discriminate water, heavy water, and oil according to the present embodiment;

FIGS. 14A, 14B, and 14C are schematic drawings of the images of FIGS. 13A, 13B, and 13C, depicted to facilitate an understanding of the images shown in FIGS. 13A, 13B, and 13C;

FIG. 15 is a flowchart for describing an operation example of the imaging system 1 according to an embodiment;

FIG. 16 depicts a configuration example of a graphical user interface (GUI) 1600 which is used when setting and adjusting the wavelength values and optical intensity of infrared light for simultaneous irradiation according to the present embodiment;

FIGS. 17A, 17B, 17C, and 17D show captured images of pig mesentery according to the present embodiment;

FIGS. 18A, 18B, 18C, and 18D are schematic drawings of the images of FIGS. 17A, 17B, 17C, and 17D, depicted to facilitate an understanding of the images shown in FIGS. 17A, 17B, 17C, and 17D;

FIG. 19 is a flowchart for describing an optical intensity adjustment process in the imaging system 1 according to a first modification;

FIGS. 20A and 20B illustrate examples (in the case of increasing pixel values) of the optical intensity adjustment process according to the present embodiment;

FIGS. 21A and 21B illustrate examples (in the case of decreasing pixel values) of the optical intensity adjustment process according to the present embodiment;

FIG. 22 illustrates a configuration example of a surgery assistance system 1′ according to a second embodiment;

FIG. 23 is a flowchart for describing an operation example of the surgery assistance system 1′ according to the second embodiment;

FIGS. 24A, 24B, and 24C illustrate examples of combinations of wavelengths with which it is possible to discriminate water, albumin, and oil according to the present embodiment;

FIGS. 25A, 25B, and 25C are schematic drawings of the images of FIGS. 24A to 24C, depicted to facilitate an understanding of the images shown in FIGS. 24A to 24C;

FIGS. 26A, 26B, and 26C illustrate examples of combinations of wavelengths with which it is possible to discriminate water, albumin, and oil according to the present embodiment; and

FIGS. 27A, 27B, and 27C are schematic drawings of the images of FIGS. 26A, 26B, and 26C, depicted to facilitate an understanding of the images shown in FIGS. 26A, 26B, and 26C.

### DETAILED DESCRIPTION

In the following, the present embodiments will be described with reference to the attached drawings. In the attached drawings, functionally identical elements may be designated with identical numerals. While the attached drawings illustrate embodiments and implementation examples in accordance with the principle of the present disclosure, the embodiments and implementation examples are provided to aid in understanding the present disclosure and should not be interpreted as limiting the present disclosure. The descriptions provided herein are merely illustrations of typical examples and are not intended as limiting in any way the scope of the claims of the present disclosure or application examples thereof.

The embodiments will be described in such sufficient detail as to enable those skilled in the art to carry out the present disclosure. However, it should be understood that other implementations and modes are also possible, and that various modifications of configurations and structures and substitutions of various elements are possible without departing from the scope and spirit of the technical concepts of the present disclosure. Accordingly, the following descriptions are not to be regarded as limiting.

Furthermore, the embodiments, as will be described below, may be implemented using software running on a general-purpose computer, or may be implemented using dedicated hardware or a combination of software and hardware.

### A. First Embodiment

<Appearance and Configuration of Imaging System 1>

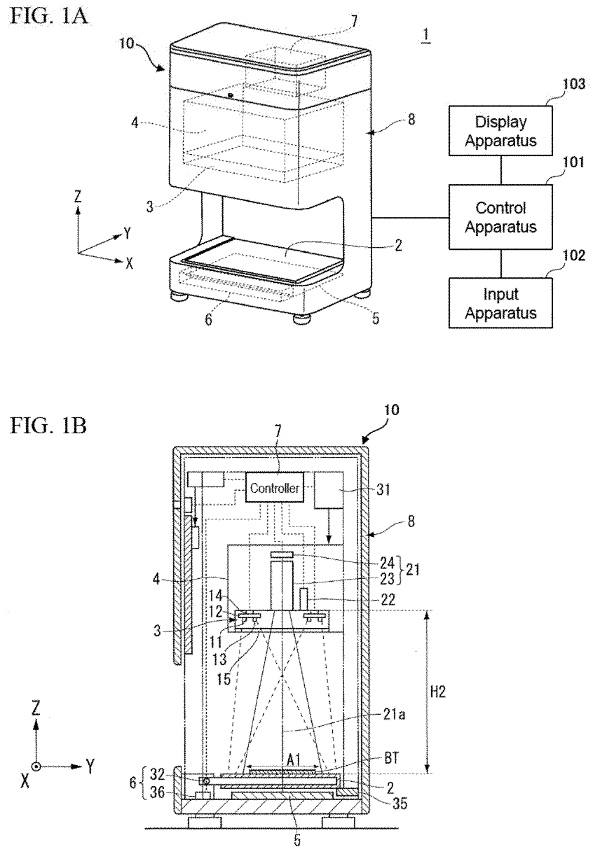

FIGS. 1A and 1B are diagrams illustrating a configuration example of an imaging system 1 according to a first embodiment. FIG. 1A illustrates a configuration example of the imaging system 1 according to the first embodiment. FIG. 1B illustrates a configuration example of an imaging apparatus 10 of the imaging system 1. In the XYZ orthogonal coordinate system indicated in the figures, the X-direction and the Y-direction are horizontal directions, for example, and the Z-direction is a vertical direction, for example. In each of the X-direction, the Y-direction, and the Z-direction, the direction of arrow will be referred to as a “+” side (for example, +X side), and the side opposite thereto will be referred to as a “−” side (for example, −X side), as appropriate.

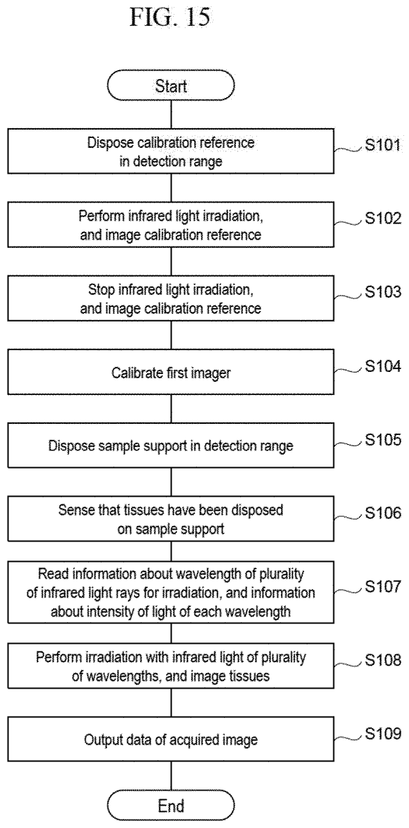

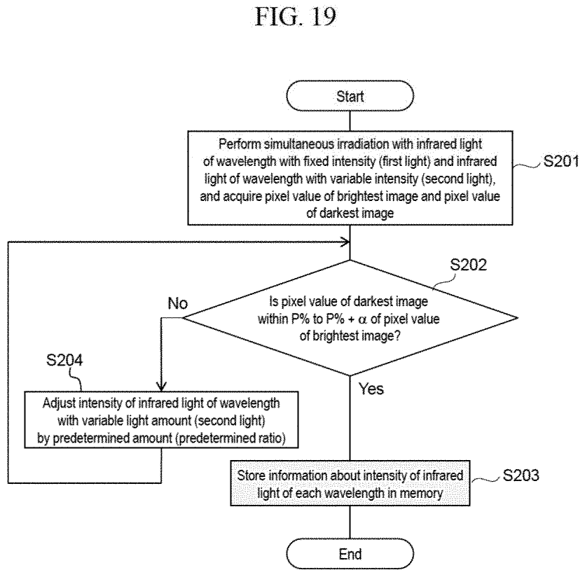

The imaging system 1 is utilized, for example, for medical assistance, such as pathological diagnosis assistance, clinical diagnosis assistance, observation assistance, and surgery assistance. As illustrated in FIG. 1A, the imaging system 1 includes an imaging apparatus 10, a control apparatus 101 for controlling the imaging system 1 as a whole, an input apparatus 102 which is used by a user (operator) to input data, instruction commands and the like, and a display apparatus 103 for displaying, for example, a graphic user interface (GUI), which will be described later, and an image obtained by the imaging apparatus 10. As illustrated in FIG. 1B, the imaging apparatus 10 includes a sample support 2, illumination units (lights) 3, a detection unit (imaging unit) 4, a calibration reference 5, a switcher 6, a controller 7, and a container 8. The controller 7 is operated in accordance with an instruction command from the control apparatus 101, for example. That is, an instruction command input by the user (operator) via the input apparatus 102 is processed in the control apparatus 101 and transmitted to the controller 7. The control apparatus 101 also reads programs (programs corresponding to the flowcharts of FIG. 15 and FIG. 19), which will be described later, from a memory in the control apparatus 101, for example, and instructs, in accordance with the programs, the controller 7 to operate objects to be operated (such as infrared light sources 11 and visible light sources 13 of the illumination units 3, a first imager 21, and a second imager 22).

The sample support 2 supports a sample including a biological tissue BT (which may be hereafter referred to as a “sample”). The sample support 2 is a rectangular plate-like member, for example. The sample support 2 is disposed with an upper surface (mounting surface) thereof substantially parallel to the horizontal direction, for example, and is configured for mounting the tissue BT on the upper surface (mounting surface).

The tissue BT is a human tissue, for example. The tissue BT, however, may be a tissue of a living organism other than humans (for example, an animal or a plant). The tissue BT may be a tissue that has been cut from the living organism, or that is attached to the living organism. The tissue BT may be a tissue of a living organism (living body) that is alive (living tissue), or a tissue of a living organism that is dead (dead body). The tissue BT may be an object harvested from a living organism. The tissue BT may include any part (organ) of the living organism, such as a blood vessel and a skin, and may include internal organs and the like on the inside of the skin. The tissue BT may include a biological tissue having a substance (such as a fluorescent substance or a phosphorescent substance) that emits light upon being excited with light. The tissue BT may be fixed using a tissue fixing solution, such as formalin.

The illumination units 3 are disposed over the sample support 2, for example, and irradiates the tissue BT with infrared light (which is a concept including “near-infrared light” hereafter). The illumination units 3 are attached to the imaging unit 4, for example. The illumination units 3 include the infrared light sources 11, holders 12, the visible light sources 13, and light source movers 14. The infrared light sources 11 emit at least infrared light (for example, infrared light of a first wavelength and infrared light of a second wavelength). The holders 12 hold the infrared light sources 11. The holders 12 are plate-like members, for example, and hold the infrared light sources 11 on the lower surface side thereof. The light source movers 14 vary the irradiation angle of infrared light with respect to the tissue BT. In the present embodiment, the imaging apparatus 10 includes a diffuser 15. The diffuser 15 diffuses the infrared light from the infrared light sources 11. By diffusing the infrared light using the diffuser 15, it becomes possible to make uniform the infrared light with which the tissue BT is irradiated. The infrared light emitted from the infrared light sources 11 is diffused by the diffuser 15, and then irradiates the tissue BT. For example, the illumination units 3 are configured to irradiate the tissue BT with near-infrared light. For example, the illumination units 3 are also configured to irradiate the tissue BT with single, narrow wavelength-band infrared light. The illumination units 3 may also include a shadowless lamp, for example, configured to perform shadowless illumination.

In the present embodiment, the illumination units 3 may be configured to emit visible light and irradiate the tissue BT with the visible light. The visible light sources 13 are held onto the holders 12. The holders 12 hold the visible light sources 13 on the lower surface side thereof, for example. The light source movers 14 are also configured to vary the irradiation angle (for example, irradiation direction) of the visible light with respect to the tissue BT. The visible light from the visible light sources 13 is diffused by the diffuser 15 and then irradiates the tissue BT, for example. In this way, it is possible to make uniform the visible light with which the tissue BT is irradiated

The imaging unit 4 as a detection unit includes the first imager 21 and the second imager 22 as detectors. The first imager 21 is an infrared camera, for example, and captures an image of the tissue BT through infrared light irradiation. The first imager 21 detects light radiated from the tissue BT due to infrared light irradiation (for examples of the radiated light include reflected light, scattered light, transmitted light, and reflected/scattered light). The first imager 21 includes an imaging optical system (detecting optical system) 23 and an imaging element (light-receiving elements) 24. The imaging optical system 23 has an autofocus (AF) mechanism, and forms an image of the tissue BT. The first imager 21 has an optical axis 21a coaxial with an optical axis of the imaging optical system 23.

The imaging element 24 captures the image formed by the imaging optical system 23. For example, the imaging element 24 includes a two-dimensional image sensor, such as a CCD image sensor or a CMOS image sensor. As the imaging element 24, it is possible to adopt, for example, a structure which has a plurality of two-dimensionally disposed pixels, and in which a light detector, such as a photodiode, is disposed at each pixel. The imaging element 24 includes indium gallium arsenide (InGaAs) as a light detector material, for example, and has sensitivity in the wavelength band of the infrared light emitted from the infrared light sources 11. The first imager 21 has a detection range A1 corresponding to, for example, an imaging region in which the first imager 21 can capture an image over the sample support 2, or the field of view region of the first imager 21 over the sample support 2. The imaging region of the first imager 21, for example, is a region which is optically conjugate to a light reception region of the imaging element 24 (the region in which the light detectors are disposed). The field of view region of the first imager 21, for example, is a region which is optically conjugate to the inside of the field stop of the imaging optical system 23. The first imager 21 generates captured image data as imaging results (detection results), for example. The first imager 21 supplies the captured image data to the controller 7, for example.

The second imager 22 is a visible light camera, for example, and performs visible light irradiation to capture an image of the tissue BT. For example, the second imager 22 detects light due to reflection and scattering of the visible light from the visible light sources 13 on the surface of the tissue BT. The second imager 22 includes an imaging optical system (not illustrated) and an imaging element (not illustrated). The imaging optical system has an autofocus (AF) mechanism, for example, and forms an image of the tissue BT. The imaging element captures the image formed by the imaging optical system. The imaging element includes a two-dimensional image sensor, such as a CCD image sensor or a CMOS image sensor, for example. The imaging element 24 has a structure having a plurality of two-dimensionally disposed pixels, for example, in which a light detector, such as a photodiode, is disposed at each pixel. The imaging element includes Si as a light detector material, for example, and has sensitivity in the wavelength band of the visible light emitted from the visible light sources 13. The second imager 22 generates, for example, captured image data as imaging results (detection results). The second imager 22 supplies the captured image data to the controller 7, for example.

In the present embodiment, the imaging apparatus 10 includes a size changer 31. The size changer 31 causes the first imager 21 and the sample support 2 to move relative to each other in the direction of the optical axis 21a of the first imager 21, and changes the size of the detection range A1. For example, the size changer 31 is controlled by the controller 7 to cause the imaging unit 4 fitted with the first imager 21 to move, thereby causing the first imager 21 and the sample support 2 to move relative to each other in the optical axis direction (for example, the optical axis direction of the light received by a detection element) of the imager (for example, the first imager 21). In the present embodiment, the illumination units 3 having the diffuser 15 are connected to the imaging unit 4. The size changer 31 can cause the illumination units 3 to be moved integrally with the imaging unit 4.

The imaging apparatus 10 may not include the second imager 22. The second imager 22 may be included in an apparatus external to the imaging apparatus 10. The imaging apparatus 10 may not include the size changer 31. The imaging apparatus 10 may include a zoom mechanism (for example, a zoom lens) as the imaging optical system 23, for example.

<Details of Illumination Unit>

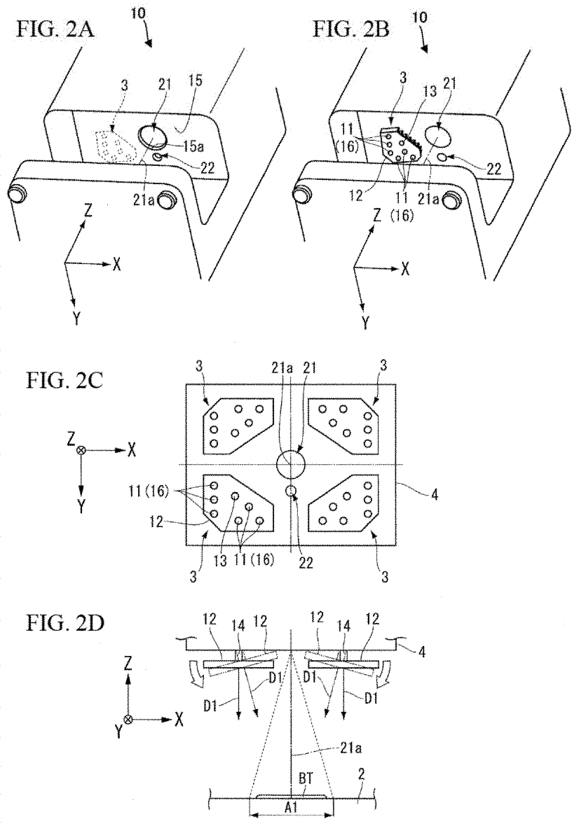

FIGS. 2A, 2B, 2C, and 2D illustrate the details of the periphery of the illumination units 3. FIG. 2A illustrates the illumination units 3 with the diffuser 15 attached thereto. FIG. 2B illustrates the illumination units with the diffuser 15 detached therefrom. FIG. 2C is a perspective view of the illumination units 3. FIG. 2D illustrates the light source movers 14.

As illustrated in FIG. 2A and FIG. 2B, the diffuser 15 is disposed so as to cover the light emitting side of the illumination units 3. The diffuser 15 has an opening 15a, and the optical path (the optical axis 21a of the first imager 21 and the periphery thereof) between the imaging unit 4 and the sample support 2 is disposed within the opening 15a. For example, the diffuser 15 is disposed on the light emitting side of the illumination units 3. The diffuser 15 is provided and configured integrally with the infrared light sources 11 and the visible light sources 13, and is disposed between the sample support 2 and the infrared light sources 11 and visible light sources 13. The diffuser 15 includes an opening (for example, an opening 15a) which is disposed on the light-receiving side of the imaging unit 4, and through which light such as infrared light and visible light (the light that has passed through the tissue BT) passes. Thus, the diffuser 15, with the openings, for example, is disposed so as to cover the light-emitting side of the infrared light sources 11 and the light-emitting side of the visible light sources 13, among the infrared light sources 11, the visible light sources 13, and the imagers (the first imager 21 and/or the second imager 22). The diffuser 15, in a state in which the calibration reference 5 is withdrawn (withdrawn state), for example, constitutes a top (ceiling) with respect to the sample support 2.

As illustrated in FIG. 2C, a plurality of the illumination units 3 are disposed around the optical axis 21a (for example, the optical axis of the light received by the light-receiving elements) of the imager (detector). In each of the illumination units 3, the infrared light sources 11 include a plurality of light sources 16. For example, the light sources 16 comprise light-emitting diodes (LED), respectively. The light sources 16 may include a solid-state light source, such as a laser diode (ID), or a lamp light source, such as a halogen lamp. The light sources 16 emit infrared light of mutually different wavelength bands. For example, the wavelength bands of the infrared light emitted by the respective light sources 16 are selected from the wavelength band of not lower than about 750 nm and not higher than about 3000 nm. The wavelength bands of the infrared light emitted from the plurality of light sources 16 are set such that the center wavelengths thereof do not overlap each other. However, the wavelength bands may overlap each other, and the two or more light sources 16 may emit infrared light of the same wavelength band. In each of the illumination units 3, as the light sources 16 included in the infrared light sources 11, six light sources are illustrated in FIG. 2C. The number of the lights, however, may be one or an arbitrary number of two or more. In each of the illumination units 3, the plurality of light sources 16 are held onto the holders 12. The plurality of light sources 16, however, may be held onto a plurality of separate members. For example, the plurality of light sources 16 are controlled by the controller 7 to emit infrared light selectively or all at once.

The visible light sources 13 include a light source, such as a light-emitting diode (LED). The light source may be a solid-state light source, such as a laser diode (LD), or a lamp light source, such as a halogen lamp. The visible light sources 13 emit, for example, visible light in a wavelength band of at least a part of the wavelength band of not lower than about 380 nm and not higher than about 750 nm. For example, the visible light sources 13 are held onto the same holders 12 as those for the plurality of light sources 16 of the infrared light sources 11. The visible light sources 13, however, may be held onto a member separate from the holders 12. As the light source for the visible light source 13 provided in each of the illumination units 3, a single light source is illustrated in FIG. 2C. However, two or more light sources may be provided for the visible light source 13 in each of the illumination units 3. When the visible light sources 13 include a plurality of light sources, the wavelength bands of the visible light emitted by the plurality of light sources may differ among two or more light sources, or may be the same among two or more light sources.

As illustrated in FIG. 2D, the light source movers 14 cause the irradiation angle of infrared light IR (for example, the irradiation direction or emission direction of the infrared light sources 11) to be changed with respect to the tissue BT. The infrared light sources 11 have an irradiation direction D1 corresponding to the direction of the central axis of the infrared light IR (beam) emitted from the infrared light sources 11. For example, the light source movers 14 cause the irradiation angle of the infrared light IR to be changed by changing the attitude of the holders 12 (for example, their angle with respect to the optical axis 21a of the first imager 21). The irradiation angle of the infrared light from the infrared light sources 11 IR is set such that, for example, the positional relationship between the infrared light sources 11 and the first imager 21 deviates from a specular reflection relationship with respect to the surface of the tissue BT. The irradiation angle of the infrared light from the infrared light sources 11 IR may be set such that the positional relationship between the infrared light sources 11 and the first imager 21 deviates from the specular reflection relationship with respect to the upper surface of the sample support 2.

For example, the light source movers 14 connect the holders 12 and the imaging unit 4, and cause the holders 12 to move (for example, pivot) with respect to the imaging unit 4. In this way, the attitude of the holders 12 is changed, and the irradiation angle of the infrared light from the infrared light sources 11 IR is changed (the irradiation direction D1 after the change is indicated by two-dot chain lines). The light source movers 14 include, for example, an actuator and gears, and transmit driving force for moving the holders 12. The controller 7 may control the irradiation angle of the infrared light IR by controlling the light source movers 14. If the light source movers 14 do not include an actuator, for example, the light source movers 14 may be driven with the human power of an operator (user). The holders 12 may be connected to (for example, supported on) an object other than the imaging unit 4, and may be not connected to (for example, supported on) the imaging unit 4. The light source movers 14 may change the irradiation angle of infrared light for each of the illumination units 3, or may change the irradiation angle of infrared light for two or more of the illumination units 3 at once, using a linkage mechanism, for example.

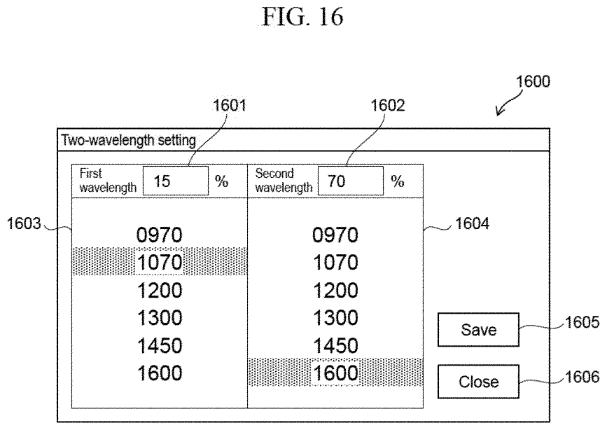

The controller 7 calculates voltage values (for example, the values of voltages to be applied to the light sources) corresponding to the optical intensity of infrared light of each wavelength set by the operator (see FIG. 16), for example. The controller 7 also controls a power supply circuit (not illustrated) so that the calculated voltage values are applied simultaneously (at the same timing) to the infrared light source drivers (not illustrated) of the of the infrared light sources 11 that output infrared light of the selected wavelengths. Then, the infrared light sources to which the voltages have been applied emit (output) infrared light of the respectively corresponding wavelengths simultaneously (at the same timing). The infrared light emitted from the respective infrared light sources irradiate the tissue BT simultaneously. The controller 7 may be configured, for example, to apply a calculated voltage to the driver of at least one of the selected plurality of infrared light sources to start emission of infrared light (for example, infrared light of a first wavelength or first infrared light) of a predetermined wavelength (for example, a first wavelength), and may be configured to apply, at a different timing, a calculated voltage to the driver of the infrared light source that outputs infrared light (for example, infrared light of a second wavelength or second infrared light) of another wavelength (for example, a second wavelength) to perform emission. In this case, the controller 7 controls the drivers of the infrared light sources 11 in such a way that, while the tissue BT is being irradiated with infrared light of the predetermined wavelength (the first wavelength), the tissue BT is irradiated with infrared light of the other wavelength (the second wavelength). Thus, the tissue BT is irradiated with a plurality of rays of infrared light simultaneously (in a superimposed manner) for a certain time.

While the plurality of illumination units 3 have the same configuration, two or more of the illumination units 3 may have mutually different configurations. For example, one of the illumination units 3 may differ from the other illumination units 3 in at least one of: the positional relationship of the plurality of light sources 16 with respect to the holders 12; the number of the plurality of light sources 16; and the wavelength band of the infrared light emitted from the plurality of light sources 16. For example, the illumination units 3 are attached to the imaging apparatus 10 in a replaceable manner, and may be attached when imaging is performed by the imaging apparatus 10. At least some of the illumination units 3 may be part (such as interior lamps) of the facility in which the imaging apparatus 10 is used. The light sources (infrared light sources) 11 that output infrared light and the visible light sources 13 that output visible light may be configured as separate units. Each of the illumination units may include a single infrared light source that outputs infrared light having a plurality of wavelengths, and an optical member that transmits or reflects infrared light of each wavelength.

<Movement of Imaging Unit>

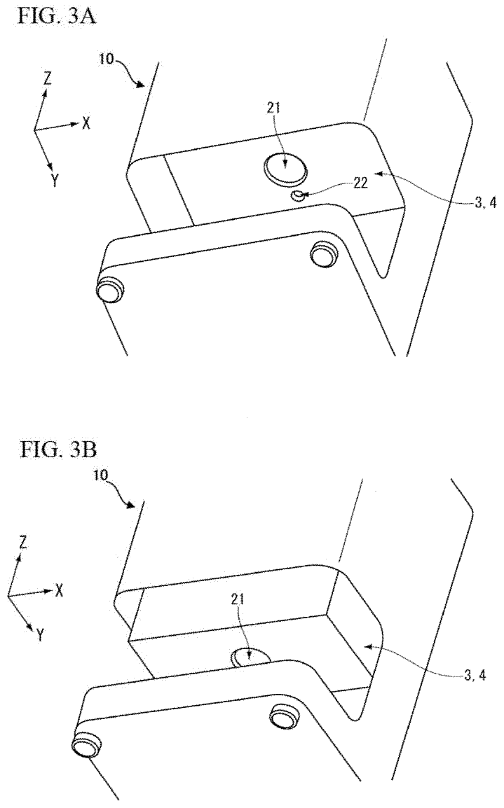

FIGS. 3A and 3B illustrate movement of the imaging unit 4 of the imaging apparatus 10 included in the imaging system 1 according to the first embodiment. Referring to FIG. 3B, the imaging unit 4 is disposed lower (in a vertical direction toward an object, for example), compared to FIG. 3A. The imaging unit 4, as it moves downward (in the vertical direction toward an object, for example), becomes closer to the opposing object (such as the sample support 2), and the detection range A1 over the object (see FIG. 1B) becomes narrower. The imaging unit 4 is able to acquire a captured image of the object in the detection range A1 with a greater magnification as the detection range A1 becomes narrower. The imaging unit 4, as it moves upward (in a vertical direction away from the object, for example), is spaced apart farther from the opposing object (such as the sample support 2), and the detection range A1 over the object (see FIG. 1B) becomes wider. The imaging unit 4 is able to acquire a captured image of the object in the detection range A1 with a smaller magnification as the detection range A1 becomes wider.

<Calibration Reference and Switcher>

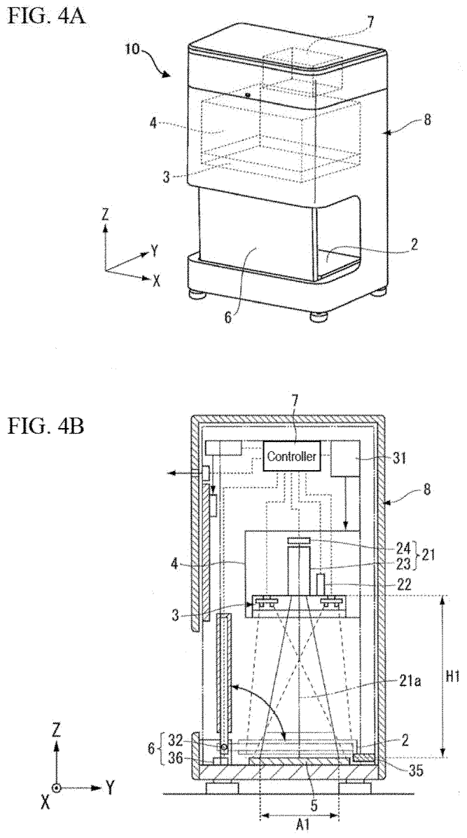

With reference to FIGS. 1A and 1B and FIGS. 4A and 4B, the calibration reference 5 and the switcher 6 will be described. FIGS. 4A and 4B illustrate the details of the calibration reference 5 and the switcher 5. For example, the calibration reference 5 includes on at least a surface thereof a calibrator (such as a standard white plate, a standard gray plate, or a standard black plate) as a measurement reference, and is used for calibrating the first imager 21 (for example, for calibrating the luminance of the light received by the light-receiving elements of the imager). For example, the calibration reference 5 is a standard white plate that has been calibrated and certified. The calibration reference 5 may be a plate-like member, a block-shaped (bulk) member, a sheet-shaped member, or a member with other shapes. The calibration reference 5 has a substantially flat reflectance in a predetermined wavelength band (for example, not lower than 300 nm and not higher than 3000 nm). The calibration reference 5 is also utilizable for calibrating the second imager 22. When calibrating the first imager 21, the controller 7 causes the calibration reference 5 to be disposed in the detection range A1 of the first imager 21 (i.e., placed in disposed state).

As illustrated in FIGS. 1A and 1B, during imaging of the tissue BT using the first imager 21, the controller 7 causes the calibration reference 5 to be disposed out of the detection range A1 of the first imager 21 (i.e., the calibration reference 5 is placed in withdrawn state). The controller 7 switches the withdrawn state (FIGS. 1A and 1B) and the disposed state (FIGS. 4A and 4B) of the calibration reference 5 by causing the calibration reference 5 and/or the sample support 2 to be moved. For example, the controller 7, when switching the calibration reference 5 from the withdrawn state (FIGS. 1A and 1B) to the disposed state (FIGS. 4A and 4B), causes the sample support 2 to be disposed out of the detection range A1 of the first imager 21. The switcher 6 is controlled by the controller 7, and causes the calibration reference 5 and the sample support 2 to move relative to each other. The controller 7 switches the withdrawn state and the disposed state of the calibration reference 5 by controlling the switcher 6.

(i) Operation when Switching Calibration Reference 5 from Withdrawn State (FIGS. 1A and 1B) to Disposed State (FIGS. 4A and 4B)

First, the operation when switching the calibration reference 5 from the withdrawn state (FIGS. 1A and 1B) to the disposed state (FIGS. 4A and 4B) will be described. When the calibration reference 5 is in the withdrawn state (FIGS. 1A and 1B), the sample support 2 and the calibration reference 5 are respectively disposed in the direction of the optical axis 21a of the first imager 21, for example. For example, the calibration reference 5 in the withdrawn state is positioned under the sample support 2 (in the Z-direction in FIGS. 4A and 4B), and is housed in the container 8 with one surface of the calibration reference 5 covered by the sample support 2. For example, the calibration reference 5 in the withdrawn state is disposed on the opposite side to the detector (imaging unit 4) with respect to at least a part of the sample support 2. For example, in the withdrawn state, the calibration reference 5 and the sample support 2 are disposed so as to oppose each other. For example, in the withdrawn state, a surface of the calibration reference 5 that has a white part for calibration is disposed opposite a mounting surface of the sample support 2 or a surface thereof opposite to the mounting surface. In the withdrawn state, for example, the sample support 2 is disposed over the calibration reference 5, and is positioned to be able to block light (for example, infrared light or visible light) that would become incident on the calibration reference 5. The controller 7 causes the sample support 2 and/or the calibration reference 5 to be rotated about an axis that is not parallel to the direction of the optical axis 21a of the first imager 21. The controller 7 also causes the sample support 2 and/or the calibration reference 5 to be rotated about an axis perpendicular or orthogonal to the direction of the optical axis 21a of the first imager 21. For example, the calibration reference 5 in the withdrawn state (FIGS. 1A and 1B) is held on the opposite side to the first imager 21 with respect to the sample support 2. For example, at least a part of the calibration reference 5 (for example, a surface or a face of the calibration reference 5) in the withdrawn state is covered by the sample support 2. In the withdrawn state, the surface of the calibration reference 5 that is formed with the calibrator is covered with the sample support 2. When the calibration reference 5 is in the withdrawn state, the sample support 2 is positioned to block an optical path between the calibration reference 5 and the first imager 21, for example.

The controller 7, when switching the calibration reference 5 to the disposed state (FIGS. 4A and 4B), causes the sample support 2 to be rotated. The sample support 2 is made of a rectangular plate member, for example, and has one end (the −Y-side end) of each of its sides (for example, the short sides) parallel to the Y-direction supported on a rotational axis 32. The rotational axis 32 is parallel to the X-direction (for example, parallel to the long sides of the sample support 2), for example, and is rotatable about the X-direction. The switcher 6 includes the rotational axis 32, an actuator 36 for supplying a driving force to the rotational axis 32, and a transmitter (not illustrated) for transmitting the driving force from the actuator 36 to the rotational axis 32.

The controller 7, when switching to the disposed state illustrated in FIGS. 4A and 4B, controls the actuator 36 of the switcher 6, and causes the sample support 2 to be rotated about the rotational axis 32 in a direction away from the calibration reference 5 (in a counterclockwise direction in FIGS. 4A and 4B). The calibration reference 5, as the sample support 2 is withdrawn from the optical path between the calibration reference 5 and the first imager 21, is disposed in the detection range A1 of the first imager 21.

The controller 7 may determines, based on position information pertaining to the sample support 2, whether the switcher 6 is being operated. For example, the imaging apparatus 10 includes a position sensor for detecting the position of the sample support 2, and the controller 7, based on the results of detection by the position sensor (position information), may determine whether the sample support 2 is being operated. The position sensor may be an encoder provided in the switcher 6. The controller 7, when prohibiting or limiting the operation of the size changer 31, may notify the user through the blinking of a lamp, a voice or the like.

(ii) Operation when Switching Calibration Reference from Disposed State (FIGS. 4A and 4B) to Withdrawn State (FIGS. 1A and 1B)

The operation when switching the calibration reference S from the disposed state (FIGS. 4A and 4B) to the withdrawn state (FIGS. 1A and 1B) will be described. The controller 7, when switching the calibration reference 5 from the disposed state (FIGS. 4A and 4B) to the withdrawn state (FIGS. 1A and 1B), controls the actuator 36 of the switcher 6, and causes the sample support 2 to be rotated in a direction toward the calibration reference 5 (a clockwise direction in FIGS. 4A and 4B). The calibration reference 5, as the optical path between the calibration reference 5 and the first imager 21 is blocked by the sample support 2, is disposed out of the detection range A1 of the first imager 21.

The sample support 2 has the other end (+Y-side end) of each of its sides (for example, short sides) parallel to the Y-direction supported on the stopper 35, for example. Thus, the rotational position of the sample support 2 in the clockwise direction as viewed from the +X side is regulated. The stopper 35 regulates the rotational position of the sample support 2 so that the sample support 2 and the calibration reference 5 do not contact (collide with) each other, for example. The calibration reference 5 in the withdrawn state is disposed without contacting the sample support 2, for example.

<Container>

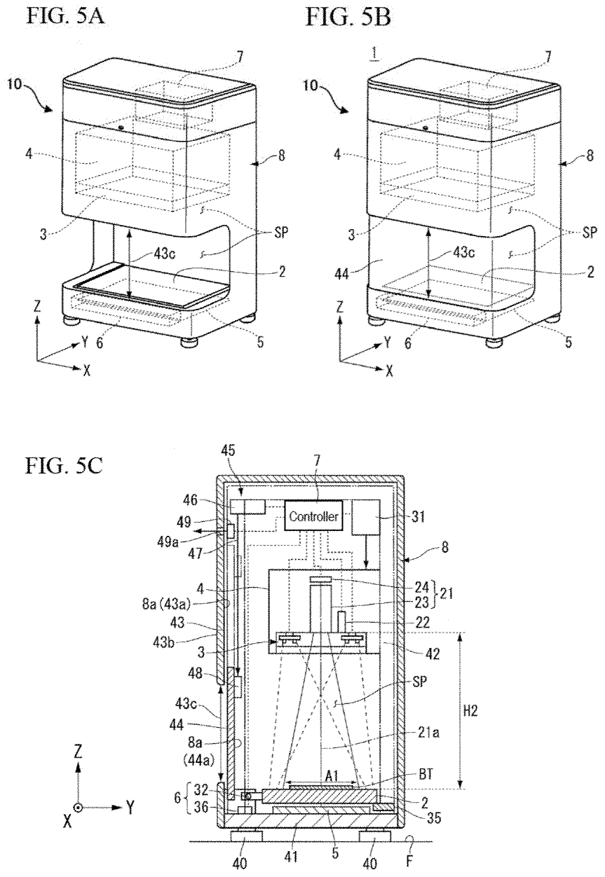

The container 8 will be described. FIGS. 5A, 5B, and 5C illustrate the container (which may also be referred to as a housing) 8 of the imaging apparatus 10 according to the present embodiment. The container 8 contains the sample support 2 and the imaging unit 4 (for example, the first imager 21). The container 8 has an internal container space SP for containing the sample support 2 and the imaging unit 4. The container 8 is configured to open the container space SP externally. FIG. 5A illustrates a state in which the container space SP is open (open state). FIG. 5B illustrates a state in which the container space SP is closed. FIG. 5C is a cross sectional view of the imaging apparatus 10 from the +X-direction, illustrating irradiation of the detection range A1 of the sample support 2 with infrared light in the state in which the container space SP is closed (closed state, blocked state).

The container 8, in the state in which the container space SP is closed (closed state, blocked state), functions as a dark box (dark chamber) capable of maintaining a state in which external light from the outside of the container 8 (for example, from the inside of the imaging apparatus 10 except for the container 8, or the outside of the imaging apparatus 10), for example, is blocked. The container 8, in the state in which the container space SP is closed, for example, suppresses (reduces) the advance (entry) of light from the outside of the container 8 (such as external light, light from an interior lamp, or natural light) into the optical path of infrared light (or the optical path of visible light). The optical path of infrared light in the container space SP includes, for example, an optical path from the infrared light sources 11 to the detection range A1 of the first imager 21 (for example, the tissue BT, the sample support 2, the calibration reference 5, and the illuminated region), and at least a part of an optical path from the detection range A1 to the first imager 21.

The container 8 includes, for example, legs 40, a base 41, a frame 42 (indicated by two-dot chain lines), a cover 43, and a door member 44. The legs 40 are disposed adjacent to an installation surface F (for example, the upper surface of a desk) on which the imaging apparatus 1 is installed. The base 41 is disposed over the legs 40 and supported on the legs 40. The frame 42 is disposed over the base 41 and is supported on the base 41. The frame 42 is fitted with, for example, at least a part of the controller 7, the imaging unit 4, the illumination units 3, the size changer 31, and a door driver 45 (which will be described later). The cover 43 is disposed over the base 41 without contacting the frame 42, for example, and is supported on the base 41. The cover 43 includes an inner surface 43a facing the inside (container space) of the container 8, and an outer surface 43b facing the outside of the container 8. The imaging unit 4 (for example, the first imager 21) is not in contact with the cover 43, and is supported so as to suppress (reduce) transmission of force from the cover 43.

The cover 43 includes an opening 43c for opening the container space SP externally. The door member 44 is movable between a position for closing the opening 43c (hereafter referred to as a closed position), and a position for opening at least a part of the opening 43c externally (hereafter referred to as an open position). The closed position of the door member 11 is the position in which, for example, the position of the lower end of the door member 44 is disposed at the position of the lower end of the opening 15a or thereunder.

<Door Driver>

Still referring to FIGS. 5A, 5B, and 5C, the door driver will be described. The imaging apparatus 10 includes the door driver 45 for driving the door member, for example. The door driver 45 includes, for example, an actuator 46 and a transmitter 47. The actuator 46 includes an electric motor, for example, and is controlled by the controller 7 to generate a driving force for moving the door member 44. The transmitter 47 transmits the driving force from the actuator 46 to the door member 44.

The door driver 45 includes a contactless sensor 49, for example. The controller 7 controls the door driver 45 based on the results of detection by the contactless sensor 49. For example, the contactless sensor 49 optically detects a user input (such as an operation). The contactless sensor 49 emits light externally through a window 49a provided in the cover 43, and detects reflected light of the emitted light. For example, when the user has placed his or her hand over the window 49a, the intensity of the reflected light detected by the contactless sensor 49 changes from below a threshold value to be greater than or equal to the threshold value. In this case, the controller 7 causes the door member 14 to be moved between the open position and the closed position, thereby controlling the open/closed state of the door driver 45.

The controller 7 may determine whether the door driver 45 is in operation based on position information pertaining to the door member 44. For example, the imaging apparatus 10 includes a position sensor for detecting the position of the door member 11. Then, the controller 7 may determine whether the door driver 45 is in operation based on the results of detection (position information) by the position sensor. The position sensor may be configured from an encoder or the like provided in the door driver 45. The controller 7, when prohibiting or limiting the operation of the switcher 6, or when limiting or prohibiting the movement of the door member 44 due to the door driver 45, may notify the user via blinking of a lamp, voice or the like.

<Photography Using Light of a Plurality of Wavelengths>

According to the present embodiment, the imaging system 1 irradiates the tissue BT with light of a plurality of wavelengths simultaneously to detect light radiated from the tissue BT, and generates an image of the tissue BT from the detected light. Herein, as an example, a technique for capturing an image the tissue BT through simultaneous irradiation with light of a plurality of wavelengths will be described. Meanwhile, the present embodiment will be described with reference to the case in which two wavelengths (for example, a first wavelength of 750 nm to 1100 nm and a second wavelength of 1200 nm to 1650 nm) of light (for example, first-wavelength infrared light and second-wavelength infrared light) are used for simultaneous irradiation. In this case, the first wavelength light and the second wavelength light may be synthesized on the tissue BT. However, the number of the wavelengths used is not limited to two, and three or more wavelengths may be used.

(i) Absorbance Curve (or a Spectrum of Light (Spectral Distribution, Optical Spectrum))

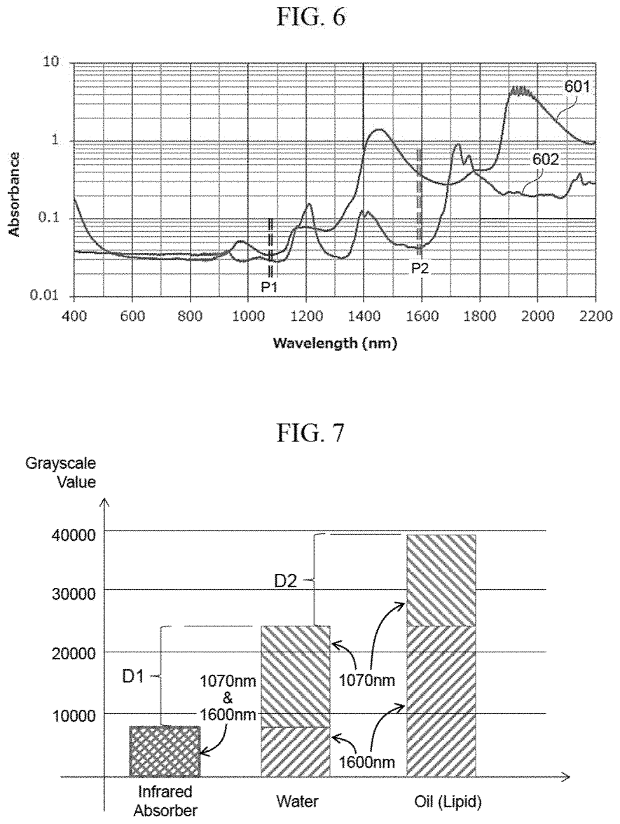

FIG. 6 is a diagram illustrating the absorbance (absorbance curves, spectral distributions, and optical spectra) by wavelength (infrared light region) with respect to water and oil (for example, vegetable oil). While in FIG. 6 vegetable oil is used as an example of oil, the relationship between wavelength and absorbance is considered to have similar characteristics in the case of lipids that exist in living tissues. For example, lipids refer to a substance that has a long-chain fatty acid or a similar hydrocarbon chain in a molecule, and that is found in living organisms or derived from living organisms. Lipids is the collective name for those substances found in living organisms that do not dissolve in water. Fats are included in the concept of a lipid (a fat=a simple lipid: a combination of fatty acids and glyceride), and generally refer to neutral fats. For example, neutral fats include monoglycerides (one fatty acid), diglycerides (two fatty acids), and triglycerides (three fatty acids).

As indicated in FIG. 6, an absorbance curve 601 for water and an absorbance curve 602 for oil provides the following insights. For example, with respect to infrared light of a wavelength ranging from around 700 nm to around 1300 nm, both water and oil have low absorbance. Accordingly, if both water and oil are irradiated with infrared light with a wavelength lower than or equal to about 1300 nm, both water and oil will be imaged brightly. Thus, if water and oil are both irradiated with light with a wavelength at a point P1 in FIG. 6 (for example, infrared light with a wavelength around 1070 nm), both water and oil will be imaged brightly.

On the other hand, for example, with respect to infrared light of wavelengths from around 1400 nm to around 1650 nm, there is a relatively large difference in absorbance between water and oil. Accordingly, if infrared light of wavelengths of not lower than about 1400 nm and not higher than about 1650 nm is irradiated, water will be imaged darkly and oil will be imaged brightly. Thus, if both water and oil are irradiated with light with a wavelength at point P2 in FIG. 6 (for example, infrared light with a wavelength around 1600 nm), water will be imaged darkly and oil will be imaged brightly.

Further, if water and oil are irradiated with infrared light of wavelengths from around 1700 nm to around 1800 nm, for example, water and oil will be imaged with nearly equal darkness (brightness). If water and oil are irradiated with infrared light of wavelengths from around 1900 nm to around 2100 nm, water will be imaged very darkly, and oil will be imaged somewhat darkly but more brightly than water.

As described above, it will be seen that the brightness/darkness of the captured image of water and oil differs depending on the difference in wavelength of the infrared light with which the sample is irradiated. Thus, by appropriately selecting the infrared light for irradiation, it becomes possible to discriminate water (moisture) and oil (lipid). For example, by using a plurality of infrared light rays that have been set based on the optical spectrum of the substance in the infrared wavelength region (for example, not lower than 700 nm and not higher than about 3500 nm) and that have mutually different wavelengths, it is possible to acquire an image having light-dark differences in predetermined portions of the sample.

If, for example, water and oil are irradiated with infrared light of 1600 nm having high absorbance in water, it is possible to discriminate water (moisture) and oil (lipid). However, if there is a substance that absorbs infrared light, of which the concept includes near-infrared light (for example, an infrared absorber (including near-infrared absorbers): substances that when irradiated with infrared light absorb infrared light and become imaged darkly) in the examination region of the tissue BT (a detection region or an imaging region), the infrared absorber also be imaged darkly at the wavelength 1600 nm, similarly to as water. Accordingly, it becomes difficult to discriminate water and an infrared absorber at 1600 nm. Meanwhile, if, for example, water and oil are irradiated with infrared light of 1070 nm, water and oil will be both imaged brightly; however, an infrared absorber would be imaged darkly as it absorbs infrared light of 1070 nm as well. Thus, in the present embodiment, in view of the property of the human eye that an object (for example, the shape and the like of an object is formed by a collection of grayscale values) is recognized by the level of grayscale values with respect to an image, the grayscale values of water or oil are raised to make an image easier to view by the human eye, thereby making it possible to discriminate between water (moisture) or oil (lipid) and an infrared absorber.

(ii) Gradation Value Raising Effect

FIG. 7 is a diagram for describing the grayscale value raising effect (the effect of increasing grayscale value) in the present embodiment. As illustrated in FIG. 7, when an infrared absorber, water, and oil (lipid) are irradiated with infrared light with the wavelength of 1600 nm, the grayscale values of the acquired image are respectively about 8000, about 8000, and about 24000, so that an oil portion becomes light, while the water portion and the infrared absorber portion become dark.

In the case of a state in which, as illustrated in FIG. 7, while irradiation with. infrared light of 1600 nm is being maintained, the infrared absorber, water, and oil (lipid) are irradiated with infrared light of 1070 nm (in this case, a state in which the samples are irradiated simultaneously with infrared light of two wavelengths (for example, 1600 nm and 1070 nm)), the grayscale values of the acquired image are respectively about 8000, about 24000, and about 39500, so that the oil portion and the water portion become light, while the infrared absorber portion remains dark.

Thus, through the simultaneous irradiation with infrared light of 1070 nm and infrared light of 1600 nm, for example, it becomes possible to increase, while the infrared absorber portion is kept dark (i.e., with the grayscale value of the infrared absorber portion being kept constant and not changed), the grayscale value of the substance (in the example of the present embodiment, water (moisture)) of which the captured image becomes dark with irradiation with infrared light of 1600 nm or becomes light with irradiation with infrared light of 1070 nm, to somewhere (for example, in the middle) between the grayscale value of the substance (in the example of the present embodiment, oil (lipid)) of which the captured image becomes light with both irradiation with infrared light of 1070 nm and irradiation with infrared light of 1600 nm, and the grayscale value of the substance (in the example of the present embodiment, the infrared absorber) of which the captured image becomes dark with both irradiation with infrared light of 1070 nm and irradiation with infrared light of 1600 nm. Accordingly, in the present embodiment, by irradiating the samples simultaneously with a plurality of rays of infrared light having mutually different wavelengths (for example, infrared light of two wavelengths), it becomes possible to obtain, as the result of detection, a grayscale value-corrected image (for example, an infrared light image with adjusted grayscale values). In the imaging apparatus 10 of the present embodiment, it is also possible, with the controller 7, to decreases grayscale values (a grayscale value lowering effect), for example, as will be described later. In this case, too, in the present embodiment, by irradiating the samples with a plurality of rays of infrared light simultaneously, it becomes possible to obtain, as the result of detection a grayscale value-corrected image (for example, an infrared light image with adjusted grayscale values).

(iii) Gradation Value Raising Effect (Actual Image)

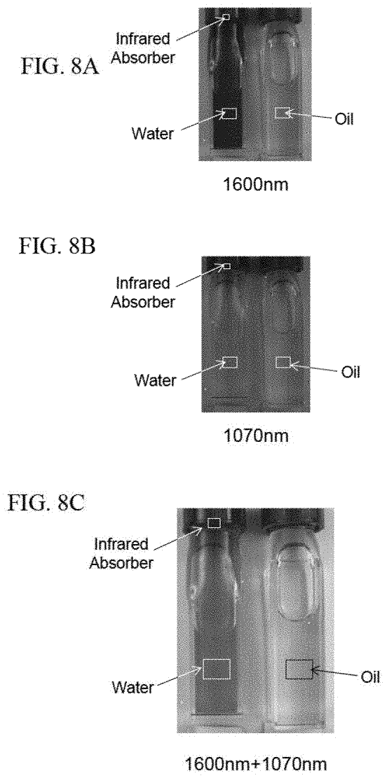

FIGS. 8A, 8B, and 8C depict actual images (detection results) illustrating the grayscale value raising effect of the present embodiment. FIGS. 8A, 8B, and 8C show, for example, two identical glass containers (for example, cuvettes or tubes) respectively containing water and oil (such as vegetable oil) and sealed with a cap serving as an infrared absorber. FIG. 8A shows a captured image when the glass containers respectively containing water and oil were irradiated with infrared light of 1600 nm. FIG. 8B shows a captured image when the glass containers respectively containing water and oil were irradiated with infrared light of 1070 nm. FIG. 8C shows a captured image when the glass containers respectively containing water and oil were irradiated with infrared light of 1070 nm and infrared light of 1600 nm simultaneously.

Referring to FIG. 8A, for example, when the glass containers were irradiated with infrared light with the wavelength of 1600 nm for imaging, the water portion contained in one container was imaged darkly, and the oil portion contained in the other container was imaged brightly. Accordingly, it is seen that while it is possible to discriminate water and oil, it is difficult to distinguish the water portion and the infrared absorber (the cap of the glass container) portion, which are both imaged darkly.

Referring to FIG. 8B, for example, when the glass containers were irradiated with infrared light with the wavelength of 1070 nm for imaging, the water portion and the oil portion were brightly imaged, and the infrared absorber portion was imaged darkly. Accordingly, it is seen that while it is possible to discriminate water and oil from the infrared absorber, it is difficult to distinguish water and oil, which are both brightly imaged.

Referring to FIG. 8C, for example, when the glass containers were irradiated with infrared light with the wavelength of 1600 nm and infrared light with the wavelength of 1070 nm simultaneously for imaging, relatively the oil portion was imaged most brightly, the infrared absorber portion was imaged most darkly, and the water portion was imaged with a brightness somewhere in-between (for example, in the middle). Accordingly, it is seen that it is possible to discriminate water, oil, and the infrared absorber easily and clearly.

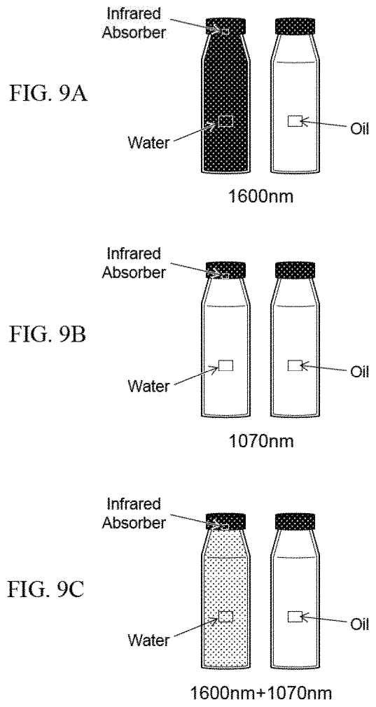

FIGS. 9A, B and C are schematic drawings which are based on the images of FIGS. 8A, 8B, and 8C and depicted to facilitate an understanding of the images. FIGS. 9A, B and C are similar to the images of FIGS. 8A, 8B, and 8C. Accordingly, description of FIGS. 9A, B and C is omitted.

Thus, the grayscale value raising effect (the substance discriminating effect) indicated by the actual images matches the grayscale value raising effect described with reference to FIG. 7. Accordingly, based on the detection result (for example, a captured image) obtained by simultaneously irradiating the sample in which a plurality of substances coexist (for example, the tissue BT) with two wavelengths of light (for example, infrared light), it becomes possible to discriminate the plurality of substances. Thus, the boundary between the plurality of substances coexisting in the sample becomes clear, making it possible to avoid the situation (risk) that, during a pathological examination, surgery or the like performed on the tissue BT, a part of the tissue BT that should not be collected or cut is collected or cut erroneously. While in the present embodiment two wavelengths have been used to discriminate two substances (for example, water and oil), three or more wavelengths may be used, and three or more substances may be discriminated using light a plurality of wavelengths. According to the present embodiment, the wavelength of irradiating light is appropriately selected based on the sample, and the sample (target) is irradiated with light of a plurality of wavelengths (for example, a plurality of rays of infrared light with a wavelength changed for each sample, such as a first sample and a second sample) simultaneously. In this way, it is possible to discriminate sugars, proteins, polypeptides, amino acids, hyaluronic acids and the like, as well as water and oil (lipid) included in the target (a sample such as the tissue BT). For example, when the tissue BT has a location with a cancerous growth, if the amount of amino acids produced at the location has increased (for example, the cancer intensifies formation of blood vessels, resulting in an increase in white blood cell count at the location of cancer growth), the imaging apparatus 10 of the present embodiment discriminates the amino acids from the other substances, making it possible to identify the cancer growth location (for example, a tumor site).

<Combination of Absorbance Curves of Water, Heavy Water, and Oil, and Wavelength of Infrared Light for Irradiation>

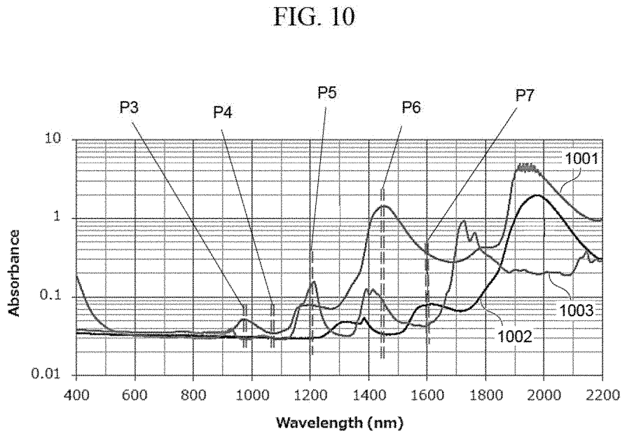

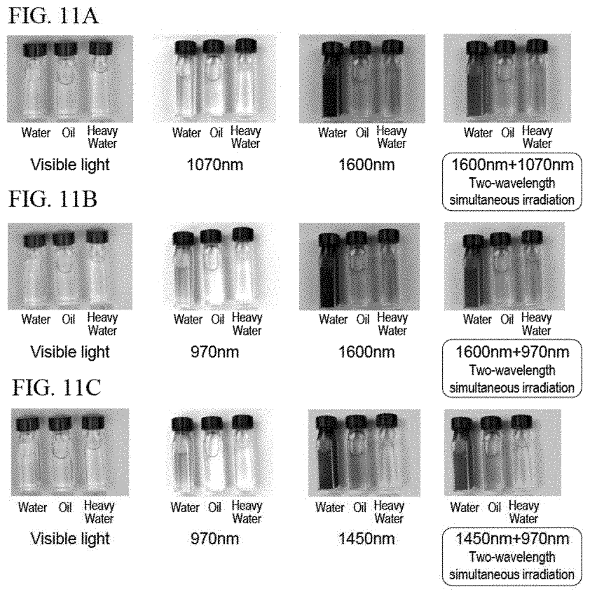

FIG. 10 illustrates the absorbance (absorbance curves, spectral distributions, and optical spectra) by wavelength (infrared light region) relating to water, heavy water, and an oil (for example, vegetable oil). In FIG. 10, a plot 1001 indicates the absorbance curve of water, a plot 1002 indicates the absorbance curve of heavy water, and a plot 1003 indicates the absorbance curve of the oil (lipid).

As illustrated in FIG. 10, for example, with respect to infrared light with the wavelength of around 700 nm to around 1100 nm, the absorbance of water, heavy water, and oil is low. Accordingly, if each (water, heavy water, and oil) is irradiated with infrared light with a wavelength shorter than or equal to about 1100 nm, the water, heavy water, and oil are each imaged brightly. For example, if water, heavy water, and oil are irradiated with light with wavelengths at points P3 and P4 in FIG. 10 (for example, infrared light with wavelengths of around 970 nm and around 1070 nm), all of the water, heavy water, and oil (lipid) will be imaged brightly.

For example, the absorbance of water and the absorbance of oil (lipid) begin to increase at the wavelength of around 1130 to around 1140 nm. The absorbance of oil (lipid) becomes maximum at the wavelength of around 1200 nm, and becomes smaller toward around 1300 nm. The absorbance of water exhibits substantially no change between the wavelengths of around 1200 nm to around 1300 nm, and begins to increase sharply as the wavelength exceeds 1300 nm. The absorbance of heavy water remains low between the wavelengths of around 1240 nm and around 1000 nm, and begin to increase slightly as the wavelength exceeds around 1240 nm. At the wavelength of 1300 nm, the absorbance of oil is lower than the absorbance of heavy water. Accordingly, for example, if water, heavy water, and oil are irradiated with light with a wavelength at point P5 in at FIG. 10 (for example, infrared light with a wavelength of around 1200 nm), heavy water will be imaged most brightly, oil (lipid) will be imaged most darkly, and water will be imaged more brightly than oil (lipid) but more darkly than heavy water.

Further, for example, with respect to infrared light with wavelengths of around 1400 nm to around 1550 nm, water, heavy water, and oil have relatively large differences in absorbance. Accordingly, if irradiated with infrared light with a wavelength longer than or equal to about 1400 nm and shorter than or equal to about 1550 nm, water will be imaged darkly, oil and heavy water will be imaged brightly (with respect to infrared light of around 1400 nm to around 1500 nm, heavy water will be imaged more brightly than oil). For example, if water, heavy water, and oil are irradiated with light with a wavelength at point P6 in FIG. 10 (for example, infrared light with a wavelength of around 1450 nm), water will be imaged most darkly, and heavy water and oil (lipid) will be imaged brightly.

At a wavelength of around 1,500 nm, the absorbance is increased in the order of water, oil (lipid), and heavy water. However, at a wavelength of around 1530 nm, the absorbance of heavy water and the absorbance of oil (lipid) are reversed. As the wavelength exceeds 1600 nm, the absorbance of oil (lipid) increases sharply, exceeds the absorbance of heavy water again at around 1650 nm, and further even exceeds the absorbance of water at a wavelength of around 1700 nm. Thereafter, at a wavelength of around 1800 nm, again the absorbance of water becomes higher than the absorbance of oil (lipid). At a wavelength of around 1850 nm and above, the absorbance is increased in the order of water, heavy water, and oil (lipid). For example, if water, heavy water, and oil are irradiated with light with a wavelength at point P7 in FIG. 10 (for example, infrared light with a wavelength of around 1600 nm), water will be imaged most darkly, oil will be imaged most brightly, and heavy water will be imaged more brightly than water but more darkly than oil. If, for example, water, heavy water, and oil are irradiated with infrared light with a wavelength of around 1700 nm to around 1800 nm, water and oil will be imaged darkly, and heavy water will be imaged brightly. Further, for example, if water, heavy water, and oil are irradiated with infrared light with a wavelength of from around 1900 nm to around 2100 nm, water and heavy water will be imaged very darkly, and oil will be imaged somewhat darkly but more brightly than water and heavy water.

Thus, as described above, it is seen that, due to the difference in wavelength of the infrared light with which the sample is irradiated, the brightness/darkness of the captured image differs among water, heavy water, and oil. Accordingly, by appropriately selecting the wavelength of the infrared light for irradiation, it becomes possible to discriminate water, heavy water, and oil (lipid).

<Combinations (Examples) of Wavelengths for Discriminating Water, Heavy Water, and Oil>

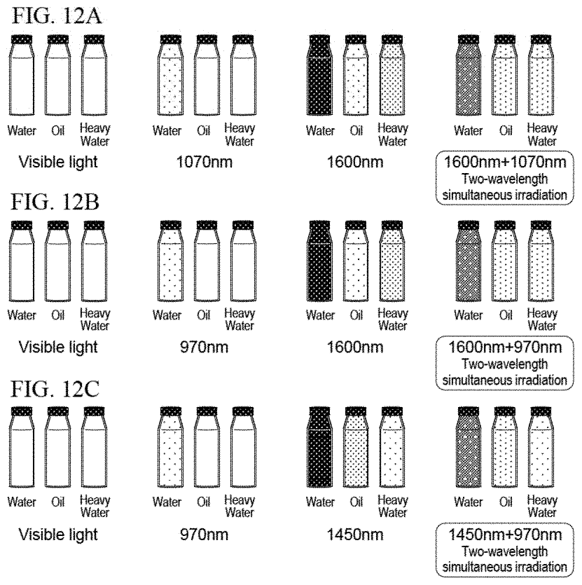

FIGS. 11A to 11C and FIGS. 12A to 12C show examples of combinations of wavelengths with which it is possible to discriminate water, heavy water, and oil. In the three containers in each figure, the container on the left (in this case, a cuvette) contains water; the container at the center (in this case, a cuvette) contains oil (vegetable oil); and the container on the right (tor example, a cuvette) contains heavy water. Each container is sealed with a cap serving as an infrared absorber.

(i) Simultaneous Irradiation with Infrared Light of Two Wavelengths (1070 nm 1600 nm)

FIG. 11A shows captured images (detection results) including one obtained by irradiating each container with infrared light of 1070 nm and infrared light of 1600 nm simultaneously. FIG. 11A shows four images which are, in order from the left, an image (visible image) obtained by irradiating each container with visible light; an image (single-wavelength infrared image) obtained by irradiating each container with infrared light of 1070 nm; an image (single-wavelength infrared image) obtained by irradiating each container with infrared light of 1600 nm; and an image (multiple-wavelength infrared image) obtained by performing irradiation with infrared light of 1070 nm and infrared light of 1600 nm.

In FIG. 11A, for example, when imaging was performed through irradiation with infrared light of 1600 nm, the water portion was imaged most darkly, the oil portion was imaged most brightly, and the heavy water portion was imaged more brightly than the water portion but slightly more darkly than the oil portion. Thus, it was possible to discriminate water, oil (lipid), and heavy water. However, when a substance that absorbs infrared light (including near-infrared light), such as an infrared absorber which, when irradiated with infrared light, absorbs infrared light and is imaged darkly, existed in the examination region of the tissue BT (a detection region or an imaging region), the infrared absorber portion was also imaged darkly, similarly to the water portion, making it difficult to discriminate water and the infrared absorber. Meanwhile, when imaging was performed through irradiation with infrared light of 1070 nm, the water portion, the oil portion, and the heavy water portion were all imaged brightly. However, the infrared absorber portion also absorbed infrared light of 1070 nm and was therefore imaged darkly, similarly to when irradiated with infrared light of 1600 nm. When, for example, imaging was performed by irradiating each container with infrared light of 1600 nm and infrared light of 1070 nm simultaneously, relatively the oil portion was imaged most brightly, the heavy water portion was imaged next most brightly, the infrared absorber portion was imaged most darkly, and the water portion was imaged with a brightness somewhere (for example, in the middle) between them (for example, the oil portion and the infrared absorber, or the heavy water portion and the infrared absorber). Thus, it is seen that it is possible to discriminate water, oil, heavy water, and the infrared absorber easily and clearly. In this case, the infrared absorber portion was imaged most darkly, the water portion was imaged next most darkly, the oil portion was imaged most brightly, and the heavy water portion was imaged more brightly than the water portion and slightly more darkly than the oil portion.

As described above, based on the detection result (for example, a captured image) obtained by irradiating the sample with infrared light of 1070 nm and infrared light of 1600 nm simultaneously, it is possible to discriminate water, heavy water, oil, and the infrared absorber simply and effectively. For example, based on the detection result, the operator can discern, in the tissue BT, a site that contains water (moisture) more than any other substances; a site that contains a lipid more than any other substances; and a site that contains heavy water more than any other substances.

(ii) Simultaneous Irradiation with Infrared Light of Two Wavelengths (970 nm+1600 nm)

FIG. 11B shows captured images (detection results) including one obtained by irradiating each container with infrared light of 970 nm and infrared light of 1600 nm simultaneously. FIG. 11B shows four images which are, in order from the left, an image (visible image) obtained by irradiating each container with visible light; an image (single-wavelength infrared image) obtained by irradiating each container with infrared light of 970 nm; an image (single-wavelength infrared image) obtained by irradiating each container with infrared light of 1600 nm, and an image (multiple-wavelength infrared image) obtained through irradiation with infrared light of 970 nm and infrared light of 1600 mm.

As shown in FIG. 11B, results similar to those of FIG. 11A were obtained. For example, when imaging was performed through irradiation of each container with infrared light of 1600 nm and infrared light of 970 nm simultaneously, relatively the oil portion was imaged most brightly, the heavy water portion was imaged next most brightly, the infrared absorber portion was imaged most darkly, and the water portion was imaged with a brightness somewhere (for example, in the middle) between them (for example, between the oil portion and the infrared absorber, or between the heavy water portion and the infrared absorber). Thus, it is seen that it was possible to discriminate water, oil, heavy water, and the infrared absorber easily and clearly. Accordingly, also in the case of FIG. 11B, the infrared absorber portion was imaged most darkly, the water portion was imaged next most darkly, the oil portion was imaged most brightly, and the heavy water portion was imaged more brightly than the water portion and slightly more darkly than the oil portion.

Accordingly, based on the detection result (for example, a captured image) obtained through simultaneous irradiation of the sample (for example, the tissue BT) with infrared light of this wavelength combination, it is possible to discriminate water, heavy water, oil, and the infrared absorber simply and effectively.

(iii) Simultaneous Irradiation with Infrared Light of Two Wavelengths (970 nm+1450 nm)

FIG. 11C shows captured images (detection results) including one obtained by simultaneously irradiating each container with infrared light of 970 nm and infrared light of 1450 nm. FIG. 11C shows four images which are, in order from the left, an image (visible image) obtained by irradiating each container with visible light; an image (single-wavelength infrared image) obtained by irradiating each container with infrared light of 970 nm; an image (single-wavelength infrared image) obtained by irradiating each container with infrared light of 1450 nm; and an image (multiple-wavelength infrared image) obtained through irradiation with infrared light of 970 nm and infrared light of 1450 nm.

In FIG. 11C, for example, when imaging was performed through irradiation with infrared light of 1450 nm, the water portion was imaged most darkly, the heavy water portion was imaged most brightly, and the oil portion was imaged more brightly than the water portion but slightly more dandy than the heavy water portion. Thus, it was possible to discriminate water, oil (lipid), and heavy water. However, when the infrared absorber existed in the examination region of the tissue BT (a detection region or an imaging region) as described above, the infrared absorber portion was also imaged darkly, similarly to the water portion, making it difficult to discriminate water and the infrared absorber. Meanwhile, when imaging was performed through irradiation with infrared light of 970 nm, the water portion, the oil portion, and the heavy water portion were all imaged brightly. However, the infrared absorber portion also absorbed infrared light of 970 nm, and was therefore imaged darkly, similarly to when irradiated with infrared light of 1450 nm. When, for example, imaging was performed through irradiation of each container with infrared light of 1450 nm and infrared light of 970 nm simultaneously, relatively the heavy water portion was imaged most brightly, the oil portion was imaged next most brightly, the infrared absorber portion was imaged most darkly, and the water portion was imaged with a brightness somewhere (for example, in the middle) between them (for example, between the oil portion and the infrared absorber, or between the heavy water portion and the infrared absorber). Thus, it is seen that it is possible to discriminate water, oil, heavy water, and the infrared absorber easily and clearly. In this case, the infrared absorber portion was imaged most darkly, the water portion was imaged next most darkly, the heavy water portion was imaged most brightly, and the oil portion was imaged more brightly than the water portion but slightly more darkly than the heavy water portion. Thus, for example, by irradiating the sample with infrared light of 970 nm that allows water, heavy water, and oil to be all imaged brightly, together with infrared light of 1450 nm, it becomes possible to raise the grayscale value of each substance, while keeping the infrared absorber portion dark.

Accordingly, based on the detection result (for example, a captured image) obtained through simultaneous irradiation of the sample (for example, the tissue BT) with infrared light of this wavelength combination, it becomes possible to discriminate water, heavy water, oil, and the infrared absorber effectively.

FIGS. 12A, 12B, and 12C are schematic drawings which are based on the images of FIGS. 11A, 11B, and 11C and depicted to facilitate an understanding of the images. FIGS. 12A, 12B, and 12C are similar to the images of FIGS. 11A, 11B, and 11C. Accordingly, description of FIGS. 12A, 12B, and 12C is omitted.

(iv) Simultaneous Irradiation with Infrared Light of Two Wavelengths (1070 nm+1450 nm)

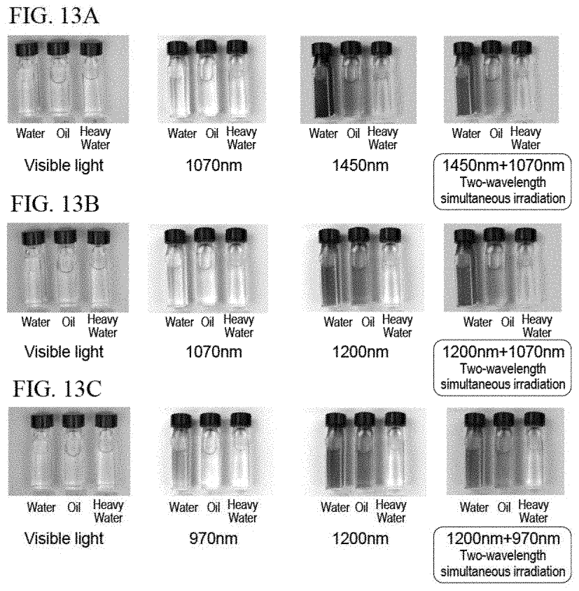

FIG. 13A shows captured images (detection results) including one obtained by irradiating each container with infrared light of 1070 nm and infrared light of 1450 nm simultaneously. FIG. 13A shows four images which are, in order from the left, an image (visible image) obtained by irradiating each container with visible light; an image (single-wavelength infrared image) obtained by irradiating each container with infrared light of 1070 nm; an image (single-wavelength infrared image) obtained, by irradiating each container with infrared light of 1450 nm; and an image (multiple -wavelength infrared image) obtained through irradiation with infrared light of 1070 nm and infrared light of 1450 nm.

As shown in FIG. 13A, results similar to those of FIG. 11C were obtained. For example, when imaging was performed through irradiation of each container with infrared light of 1070 nm and infrared light of 1450 nm simultaneously, relatively the heavy water portion was imaged most brightly, the oil portion was imaged next most brightly, the infrared absorber portion was imaged most darkly, and the water portion was imaged with a brightness somewhere (for example, in the middle) between them (for example, between the oil portion and the infrared absorber, or between the heavy water portion and the infrared absorber). Thus, it is seen that it is possible to discriminate water, oil, heavy water, and the infrared absorber easily and clearly. Accordingly, also in this case, the infrared absorber portion was imaged most darkly, the water portion was imaged next most darkly, the heavy water portion was imaged most brightly, and the oil portion was imaged more brightly than the water portion but slightly more daddy than the heavy water portion.

Accordingly, based on the detection result (for example, a captured image) obtained through simultaneous irradiation of the sample (for example, the tissue BT) with infrared light of this wavelength combination, it becomes possible to discriminate water, heavy water, oil, and the infrared absorber effectively.

(v) Simultaneous Irradiation with Infrared Light of Two Wavelengths (1070 nm+1200 nm)

FIG. 13B shows captured images (detection results) obtained by simultaneously irradiating each container with infrared light of 1070 nm and infrared light of 1200 nm. FIG. 13B shows four images which are, in order from the left, an image (visible image) obtained by irradiating each container with visible light; an image (single-wavelength infrared image) obtained by irradiating each container with infrared light of 1070 nm; an image (single-wavelength infrared image) obtained by irradiating each container with infrared light of 1200 nm; and an image (multiple-wavelength infrared image) obtained through irradiation with infrared light of 1070 nm and infrared light of 1200 nm.

In FIG. 13B, for example, when imaging was performed through irradiation with infrared light of 1200 nm, the water portion was imaged most darkly, the heavy water portion was imaged most brightly, and the oil portion was imaged more brightly than the water portion but slightly more darkly than the heavy water portion. Thus, it is possible to discriminate water, oil (lipid), and heavy water. However, as described above, when the infrared absorber existed in the examination region of the tissue BT (a detection region or an imaging region), the infrared absorber portion was also imaged darkly, similarly to the water portion, making it difficult to discriminate water and the infrared absorber. Meanwhile, when imaging was performed through irradiation with infrared light of 1070 nm, the water portion, the oil portion, and the heavy water portion were all imaged brightly. However, the infrared absorber portion also absorbed infrared light of 1070 nm, and was therefore imaged darkly, similarly to when irradiated with infrared light of 1200 nm. When, for example, imaging was performed through irradiation of each container with infrared light of 1200 nm and infrared light of 1070 nm simultaneously, relatively the heavy water portion was imaged most brightly, the oil portion was imaged next most brightly, the infrared absorber portion was imaged most darkly, and the water portion was imaged with a brightness somewhere (for example, in the middle) between them (for example, between the oil portion and the infrared absorber, or between the heavy water portion and the infrared absorber). Thus, it is seen that it is possible to discriminate water, oil, heavy water, and the infrared absorber easily and clearly. In this case, the infrared absorber portion was imaged most darkly, the water portion was imaged next most darkly, the heavy water portion was imaged most brightly, and the oil portion was imaged more brightly than the water portion but slightly more darkly than the heavy water portion. Thus, for example, by irradiating the sample with infrared light of 1070 nm together with infrared light of 1200 nm, it becomes possible to raise the gray-scale value of each substance, while keeping the infrared absorber portion dark.

Accordingly, based on the detection result (for example, a captured image) obtained through simultaneous irradiation of the sample (for example, the tissue BT) with infrared light of this wavelength combination, it becomes possible to discriminate water, heavy water, oil, and the infrared absorber effectively.

(vi) Simultaneous Irradiation with Infrared Light of Two Wavelengths (970 nm+1200 nm)

FIG. 13C shows captured images (detection results) obtained by irradiating each container with infrared light of 970 nm and infrared light of 1200 nm simultaneously. FIG. 13C shows four images which are, in order from the left, an image (visible image) obtained by irradiating each container with visible light, an image (single-wavelength infrared image) obtained by irradiating each container with infrared light of 970 nm, an image (single-wavelength infrared image) obtained by irradiating each container with infrared light of 1200 nm, and an image (multiple-wavelength infrared image) obtained through irradiation with infrared light of 970 nm and infrared light of 1200 nm.

As shown in FIG. 13C, results similar to those of FIG. 13B were obtained. For example, when imaging was performed through irradiation of each container with infrared light of 1070 nm and infrared light of 1200 nm simultaneously, relatively the heavy water portion was imaged most brightly, the oil portion was imaged next most brightly, the infrared absorber portion was imaged most darkly, and the water portion was imaged with a brightness somewhere (for example, in the middle) between them (for example, between the oil portion and the infrared absorber, or between the heavy water portion and the infrared absorber). Thus, it is seen that it is possible to discriminate water, oil, heavy water, and the infrared absorber easily and clearly. Accordingly, also in this case, the infrared absorber portion was imaged most darkly, the water portion was imaged next most darkly, the heavy water portion was imaged most brightly, and the oil portion was imaged slightly more brightly than the water portion but more darkly than the heavy water portion.

Thus, based on the detection result (for example, a captured image) obtained through simultaneous irradiation of the sample (for example, the tissue BT) with infrared light of this wavelength combination, it becomes possible to discriminate water, heavy water, oil, and the infrared absorber effectively.

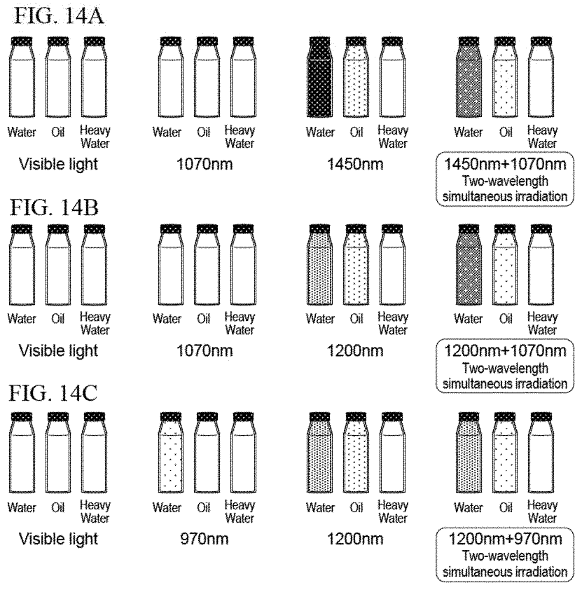

FIGS. 14A, 14B, and 14C show schematic drawings which are based on the images of FIGS. 13A, 13B, and 13C and depicted to facilitate an understanding of the images. FIGS. 14A, 14B, and 14C are similar to the images of FIGS. 13A, 13B, and 13C. Accordingly, description of FIGS. 14A, 14B, and 14C is omitted.

As described with reference to the above embodiments, by generating a sample image based on the detection result (for example, a captured image) obtained by simultaneously irradiating the sample with infrared light of a plurality of wavelengths, it becomes possible to display the sample image in such a way that the plurality of substances in the sample can be discriminated. The wavelengths of infrared light that can be selected are, for example, between 750 nm or longer and 3000 nm or shorter. The wavelengths of the infrared light used for simultaneous irradiation are mutually different wavelengths. For example, in the case of simultaneous irradiation with infrared light of two wavelengths, a first wavelength is selected from between 750 nm or longer and 1100 nm or shorter, and a second wavelength is selected from between 1400 nm or longer and 1650 nm or shorter. Depending on the sample, the substances included may differ. Accordingly, in the imaging apparatus 10 of the present embodiment, it is possible to change the combination of the wavelengths of the infrared light for irradiation depending on the type of sample. Thus, by selecting the combination of the plurality of wavelengths of the infrared light with which the sample is irradiated, it becomes possible, with the imaging apparatus 10 of the present embodiment, to generate and provide an image enabling appropriate discrimination of substances in the sample.

<Combinations (Examples) of Wavelengths for Discriminating Water, Albumin, and Oil>

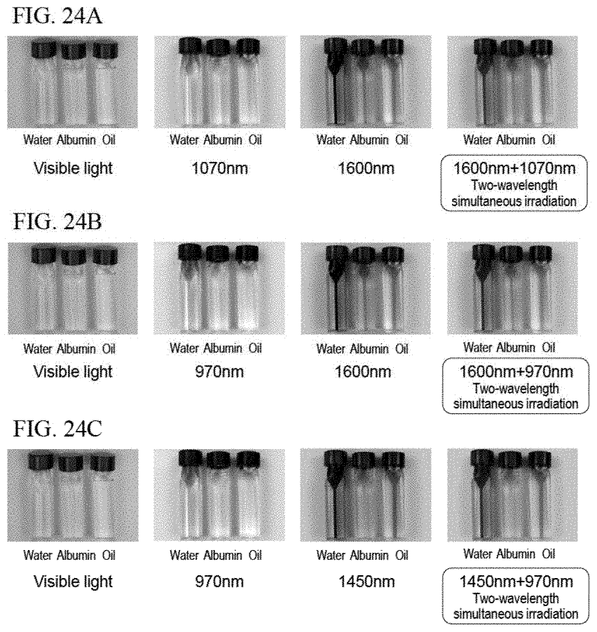

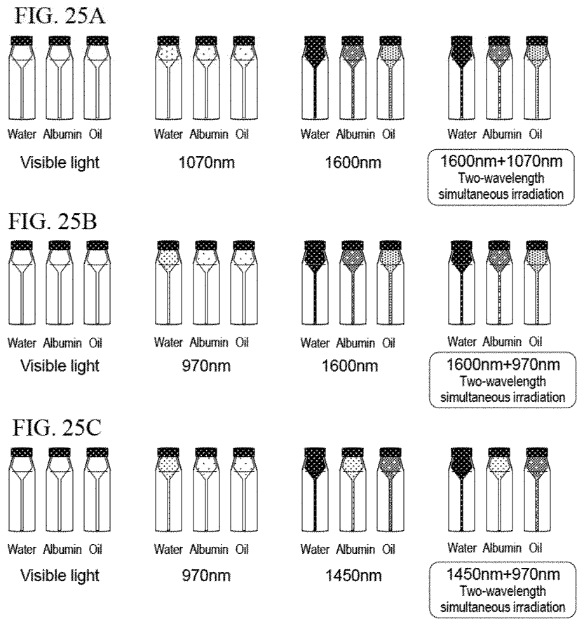

FIGS. 24A to 24C, and FIGS. 25A to 24C show examples of combinations of wavelengths with which it is possible to discriminate water, bovine serum albumin as a protein (hereafter referred to as albumin), and oil. Of the three containers shown in each figure, the container on the left (in this case, a cuvette) contains water, the container at the center (in this case, a cuvette) contains albumin, and the container on the right (for example, a cuvette) contains oil. Each container is sealed with a cap serving as an infrared absorber. The cuvettes shown in FIGS. 24A to 24C are configured to be able to contain a smaller amount of sample than the cuvettes shown in FIGS. 11A to 11C and FIGS. 13A, 13B, and 13C. In order to reduce the amount of sample that can be contained, for example, the cuvettes of FIGS. 24A to 24C are configured with the same depth and a smaller internal width compared to the cuvettes of FIGS. 11A to 11C and FIGS. 13A, 13B, and 13C. Thus, in FIGS. 24A to 24C, the portions imaged with grayscale values (such as brightly imaged portions, darkly imaged portions, and portions with grayscale values) appear thin.

(i) Simultaneous Irradiation with Infrared Light of Two Wavelengths (1070 nm+1600 nm)

FIG. 24A shows captured images (detection results) including one obtained by irradiating each container with infrared light of 1070 nm and infrared light of 1600 nm simultaneously. FIG. 24A shows four images which are, in order from the left, an image (visible image) obtained by irradiating each container with visible light, an image (single-wavelength infrared image) obtained by irradiating each container with infrared light of 1070 nm, an image (single-wavelength infrared image) obtained by irradiating each container with infrared light of 1600 nm, and an image (multiple-wavelength infrared image) obtained by performing irradiation with infrared light of 1070 nm and infrared light of 1600 nm.

Referring to FIG. 24A, for example, when imaging was performed through irradiation with infrared light of 1600 nm, the water portion was imaged most darkly, the oil portion was imaged most brightly, the albumin portion was imaged more brightly than the water portion but slightly more darkly than the oil portion. Thus, it is possible to discriminate water, albumin, and oil (lipid). However, when a substance that absorbs infrared light (including near-infrared light), such as an infrared absorber which, when irradiated with infrared light, absorbs infrared light and is imaged darkly, existed in the examination region of the tissue BT (a detection region or an imaging region), the infrared absorber portion was also imaged darkly, similarly to the water portion, making it difficult to discriminate water and the infrared absorber. Meanwhile, when imaging was performed through irradiation with infrared light of 1070 nm, the water portion, the albumin portion, and the oil portion were all imaged brightly, whereas the infrared absorber portion, which absorbs infrared light of 1070 nm as well, was imaged darkly, similarly to when irradiated with infrared light of 1600 nm. When, for example, imaging was performed through irradiation of each container with infrared light of 1600 nm and infrared light of 1070 nm simultaneously, relatively the oil portion was imaged most brightly, the albumin portion was imaged next most brightly, the infrared absorber portion was imaged most darkly, and the water portion was imaged with a brightness somewhere (for example, in the middle) between them (for example, between the oil portion and the infrared absorber, or between the albumin portion and the infrared absorber). Accordingly, it is seen that it is possible to discriminate water, albumin, oil, and the infrared absorber easily and clearly. In this case, the infrared absorber portion was imaged most darkly, the water portion was imaged next most darkly, the oil portion was imaged most brightly, and the albumin portion was imaged more brightly than the water portion and slightly darkly than the oil portion.

As described above, based on the detection result (for example, a captured image) obtained by irradiating the sample with infrared light of 1070 mm and infrared light of 1600 nm simultaneously, it is possible to discriminate water, protein (for example, albumin), oil, and the infrared absorber simply and effectively. For example, based on the detection result, the operator can discern a site that contains water (moisture) more than any other substances, a site that contains a lipid more than any other substances, and a site that contains heavy water more than any other substances in the tissue BT.

(ii) Simultaneous Irradiation with Infrared Light of Two Wavelengths (970 nm+1600 nm)

FIG. 24B shows captured images (detection results) obtained by irradiating each container with infrared light of 970 nm and infrared light of 1600 nm simultaneously. FIG. 24B shows four images which are, in order from the left, an image (visible image) obtained by irradiating each container with visible light, an image (single-wavelength infrared image) obtained by irradiating each container with infrared light of 970 nm, an image (single-wavelength infrared image) obtained by irradiating each container with infrared light of 1600 nm, and an image (multiple-wavelength infrared image) obtained through irradiation with infrared light of 970 nm and infrared light of 1600 nm.

As shown in FIG. 24B, results similar to those of FIG. 24A were obtained. For example, when imaging was performed through irradiation of each container with infrared light of 1600 nm and infrared light of 970 nm simultaneously, relatively the oil portion was imaged most brightly, the albumin portion was imaged next most brightly, the infrared absorber portion was imaged most darkly, and the water portion was imaged with a brightness somewhere (for example, in the middle) between them (for example, between the oil portion and the infrared absorber, or between the albumin portion and the infrared absorber). Thus, it is seen that it is possible to discriminate water, albumin, oil, and the infrared absorber easily and clearly. Accordingly, also in the case of FIG. 24B, the infrared absorber portion was imaged most darkly, the water portion was imaged next most darkly, the oil portion was imaged most brightly, and the albumin portion was imaged more brightly than the water portion and slightly darkly than the oil portion.

Accordingly, based on the detection result (for example, a captured image) obtained through simultaneous irradiation of the sample (for example, the tissue BT) with infrared light of this wavelength combination, it is possible to discriminate water, protein (for example, albumin), oil, and the infrared absorber simply and effectively.

(iii) Simultaneous Irradiation with Infrared Light of Two Wavelengths (970 nm+1450 nm)

FIG. 24C shows captured images (detection results) obtained by irradiating each container with infrared light of 970 nm and infrared light of 1450 nm simultaneously. FIG. 24C shows four images which are, in order from the left, an image (visible image) obtained by irradiating each container with visible light, an image (single-wavelength infrared image) obtained by irradiating each container with infrared light of 970 nm, an image (single-wavelength infrared image) obtained by irradiating each container with infrared light of 1450 nm, and an image (multiple-wavelength infrared image) obtained through irradiation with infrared light of 970 nm and infrared light of 1450 nm.

Referring to FIG. 24C, for example, when imaging was performed through irradiation with infrared light of 1450 nm, the water portion was imaged most darkly, the albumin portion was imaged most brightly, and the oil portion was imaged more brightly than the water portion and slightly more darkly than the albumin portion. Thus, it is possible to discriminate water, albumin, and oil (lipid). However, as described above, when the infrared absorber existed in the examination region of the tissue BT (a detection region or an imaging region), the infrared absorber portion was also imaged darkly, similarly to the water portion, making it difficult to discriminate water and the infrared absorber. Meanwhile, when imaging was performed through irradiation with infrared light of 970 nm, the water portion, the albumin portion, and the oil portion were all imaged brightly. However, the infrared absorber portion also absorbed infrared light of 970 nm and was therefore imaged darkly, similarly to when irradiated with infrared light of 1450 nm. When, for example, imaging was performed through irradiation of each container with infrared light of 1450 nm and infrared light of 970 nm simultaneously, relatively the albumin portion was imaged most brightly, the oil portion was imaged next most brightly, the infrared absorber portion was imaged most darkly, and the water portion was imaged with a brightness somewhere (for example, in the middle) between them (for example, between the oil portion and the infrared absorber, or between the albumin portion and the infrared absorber). Thus, it is seen that it is possible to discriminate water, albumin, oil, and the infrared absorber easily and clearly. In this case, the infrared absorber portion was imaged most darkly, the water portion was imaged next most darkly, the albumin portion was imaged most brightly, and the oil portion was imaged more brightly than the water portion and slightly more darkly than the albumin portion. Accordingly, for example, by irradiating the sample with infrared light of 970 nm that allows water, albumin, and oil to be all imaged brightly, together with infrared light of 1450 nm, it becomes possible to raise the grayscale value of each substance, keeping the infrared absorber portion dark.

Accordingly, based on the detection result (for example, a captured image) obtained through simultaneous irradiation of the sample (for example, the tissue BT) with infrared light of this wavelength combination, it becomes possible to discriminate water, protein (for example, albumin), oil, and the infrared absorber effectively.

FIGS. 25A, 25B, and 25C show schematic drawings which are based on the images of FIGS. 24A to 24C and depicted to facilitate an understanding of the images. FIGS. 25A, 25B, and 25C are similar to the images of FIGS. 24A to 24C. Accordingly, description of FIGS. 25A, 25B, and 25C is omitted.

(iv) Simultaneous Irradiation with Infrared Light of Two Wavelengths (1070 nm+1450 nm)

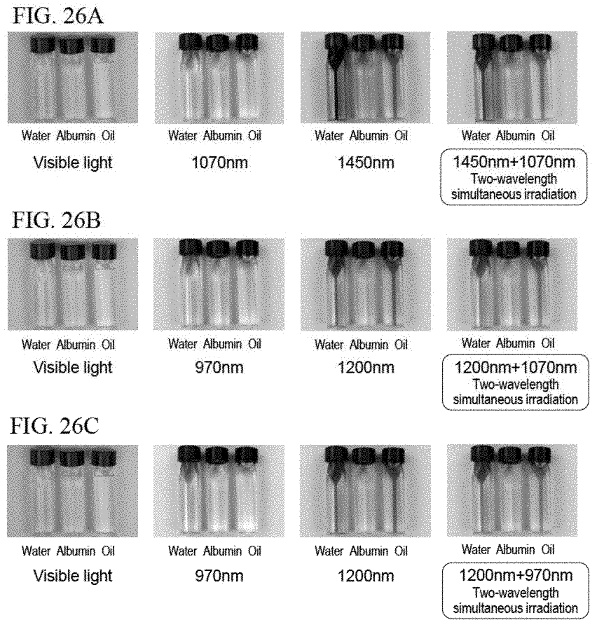

FIG. 26A shows captured images (detection results) including one obtained by irradiating each container with infrared light of 1070 nm and infrared light of 1450 nm simultaneously. FIG. 24A shows four images which are, in order from the left, an image (visible image) obtained by irradiating each container with visible light, an image (single-wavelength infrared image) obtained by irradiating each container with infrared light of 1070 nm, an image (single-wavelength infrared image) obtained by irradiating each container with infrared light of 1450 nm, and an image (multiple-wavelength infrared image) obtained through irradiation with infrared light of 1070 nm and infrared light of 1450 nm.

As shown in FIG. 26A, results similar to those of FIG. 24C were obtained, For example, when imaging was performed through irradiation of each container with infrared light of 1070 nm and infrared light of 1450 nm simultaneously, relatively the albumin portion was imaged most brightly, the oil portion was imaged next most brightly, the infrared absorber portion was imaged most darkly, and the water portion was imaged with a brightness somewhere (for example, in the middle) between them (for example, between the oil portion and the infrared absorber, or between the albumin portion and the infrared absorber). Thus, it is seen that it was possible to discriminate water, oil, albumin, and the infrared absorber easily and clearly. Accordingly, also in this case, the infrared absorber portion was imaged most darkly, the water portion was imaged next most darkly, the albumin portion was imaged most brightly, and the oil portion was imaged more brightly than the water portion and slightly more darkly than the albumin portion.

Accordingly, based on the detection result (for example, a captured image) obtained through simultaneous irradiation of the sample (for example, the tissue BT) with infrared light of this wavelength combination, it becomes possible to discriminate water, protein (for example, albumin), oil, and the infrared absorber effectively.

(v) Simultaneous Irradiation with Infrared Light of Two Wavelengths (1070 nm+1200 nm)

FIG. 26B shows captured images (detection results) obtained by irradiating each container with infrared light of 1070 nm and infrared light of 1200 nm simultaneously. FIG. 26B shows four images which are, in order from the left, an image (visible image) obtained by irradiating each container with visible light, an image (single-wavelength infrared image) obtained by irradiating each container with infrared light of 1070 nm, an image (single-wavelength infrared image) obtained by irradiating each container with infrared light of 1200 nm, and an image (multiple-wavelength infrared image) obtained through irradiation with infrared light of 1070 nm and infrared light of 1200 nm.

Referring to FIG. 26B, for example, when imaging was performed through irradiation with infrared light of 1200 nm, the water portion was imaged most darkly, the albumin portion was imaged most brightly, and the oil portion was imaged more brightly than the water portion and slightly more darkly than the albumin portion. Thus, it is possible to discriminate water, oil (lipid), and albumin. However, as described above, when the infrared absorber existed in the examination region of the tissue BT (a detection region or an imaging region), the infrared absorber portion was also imaged darkly, similarly to the water portion, making it difficult to discriminate water and the infrared absorber. Meanwhile, when imaging was performed through irradiation with infrared light of 1070 nm, the water portion, the oil portion, and the albumin portion were all imaged brightly. However, the infrared absorber portion also absorbed infrared light of 1070 nm, and was therefore imaged darkly, similarly to when irradiated with infrared light of 1200 nm. When, for example, imaging was performed through irradiation of each container with infrared light of 1200 nm and infrared light of 1070 nm simultaneously, relatively the albumin portion was imaged most brightly, the oil portion was imaged next most brightly, the infrared absorber portion was imaged most darkly, and the water portion was imaged with a brightness somewhere (for example, in the middle) between them (for example, between the oil portion and the infrared absorber, or between the albumin portion and the infrared absorber). Thus, it is seen that it is possible to discriminate water, oil, albumin, and the infrared absorber easily and clearly. In this case, the infrared absorber portion was imaged most darkly, the water portion was imaged next most darkly, the albumin portion was imaged most brightly, and the oil portion was imaged more brightly than the water portion and slightly more darkly than the albumin portion. Thus, for example, by irradiating the sample with infrared light of 1070 nm together with infrared light of 1200 nm, it becomes possible to raise the grayscale value of each substance, while keeping the infrared absorber portion dark.

Accordingly, based on the detection result (for example, a captured image) obtained through simultaneous irradiation of the sample (for example, the tissue BT) with infrared light of this wavelength combination, it becomes possible to discriminate water, protein (for example, albumin), oil, and the infrared absorber effectively.

(vi) Simultaneous Irradiation with Infrared Light of Two Wavelengths (970 nm+1200 nm)

FIG. 26C shows captured images (detection results) obtained by irradiating each container with infrared light of 970 nm and infrared light of 1200 nm simultaneously. FIG. 26C shows four images which are, in order from the left, an image (visible image) obtained by irradiating each container with visible light, an image (single-wavelength infrared image) obtained by irradiating each container with infrared light of 970 nm, an image (single-wavelength infrared image) obtained by irradiating each container with infrared light of 1200 nm, and an image (multiple-wavelength infrared image) obtained through irradiation with infrared light of 970 nm and infrared light of 1200 nm.

As shown in FIG. 26C, results similar to those of FIG. 26B were obtained. For example, when imaging was performed through irradiation of each container with infrared light of 1070 nm and infrared light of 1200 nm simultaneously, relatively the albumin portion was imaged most brightly, the oil portion was imaged next most brightly, the infrared absorber portion was imaged most darkly, and the water portion was imaged with a brightness somewhere (for example, in the middle) between them (for example, between the oil portion and the infrared absorber, or between the albumin portion and the infrared absorber). Thus, it is seen that it is possible to discriminate water, oil, albumin, and the infrared absorber easily and clearly. Accordingly, also in this case, the infrared absorber portion was imaged most darkly, the water portion was imaged next most darkly, the albumin portion was imaged most brightly, and the oil portion was imaged slightly more brightly than the water portion and more darkly than the albumin portion.

Accordingly, based on the detection result (for example, a captured image) obtained through simultaneous irradiation of the sample (for example, the tissue BT) with infrared light of this wavelength combination, it becomes possible to discriminate water, protein (for example, albumin), oil, and the infrared absorber effectively.

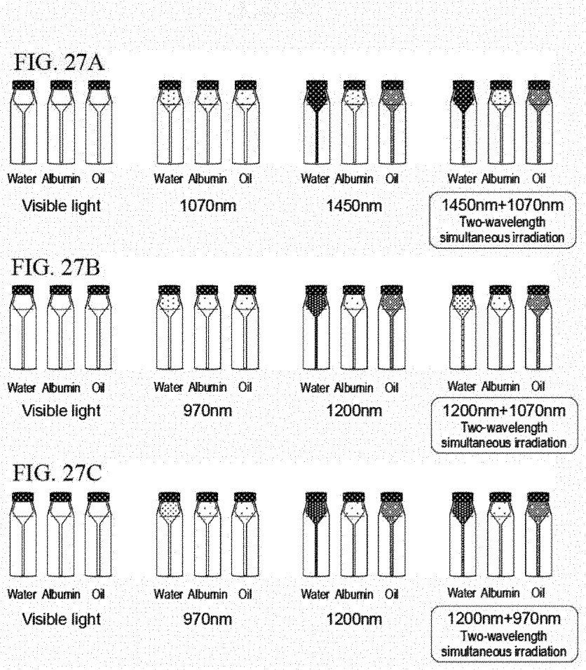

FIGS. 27A, 27B, and 27C show schematic drawings which are based on the images of FIGS. 26A, 26B, and 26C and depicted to facilitate an understanding of the images. FIGS. 27A, 27B, and 27C are similar to the images of FIGS. 26A, 26B, and 26C. Accordingly, description of FIG. 27 is omitted.

As described in the foregoing embodiments, by generating a sample image based on the detection result (for example, a captured image) obtained by irradiating the sample with infrared light of a plurality of wavelengths simultaneously, it becomes possible to display the sample image in such a way that a plurality of substances in the sample can be discriminated. The wavelengths of the infrared light that can be selected are, for example, 750 nm or longer and 3000 nm or shorter, and the wavelengths of the infrared light used for simultaneous irradiation are mutually different wavelengths. For example, in the case of simultaneous irradiation with infrared light of two wavelengths, a first wavelength is selected flour between 750 nm or longer to 1100 nm or shorter, and a second wavelength is selected flour between 1400 nm or longer and 1650 nm or shorter. For example, depending on the sample, the substances included may differ. Accordingly, in the imaging apparatus 10 of the present embodiment, it is possible to change the combination of the wavelengths of the infrared light for irradiation depending on the type of sample. Thus, by selecting the combination of the plurality of wavelengths of the infrared light with which the sample is irradiated, it becomes possible, with the imaging apparatus 10 of the present embodiment, to generate and provide an image enabling appropriate discrimination of substances in the sample. As described above, the imaging apparatus 10 of the present embodiment includes: an image sensor (detector) which includes a plurality of pixels for substantially simultaneously receiving, based on the tissue BT (sample), first infrared light (first-wavelength infrared light) and second infrared light (second-wavelength infrared light) having an intensity adjusted with respect to the first infrared light (for example, a pixel unit in which a plurality of pixels for simultaneously receiving the first infrared light and the second infrared light at the same pixel (one pixel) are disposed); and a controller which is able to adjust the intensity of the first infrared light or the intensity of the second infrared light, and generates an image of the tissue BT based on the results of detection performed by the image sensor. The capability of the imaging system 1 and the imaging apparatus 10 according to the embodiments to discriminate water, lipids, proteins, and other substances optically (through imaging or light reception) may be utilized in a monitor (camera) for monitoring during a thug discovery process. For example, the imaging apparatus 10 of the present embodiment may be applied, as part of a biological protein processing technique (e.g., for forming a scaffold of a protein), in a monitoring camera during formation of a protein film (such as an albumin film), making it possible to visualize (by time-lapse photography, for example) the state of protein film formation in real-time using infrared light.

<Operation of Imaging System>

An example of the operation of the imaging system 1 and the imaging apparatus 10 will be described. In the present embodiment, for example, the imaging system 1 performs an operation in which: the biological tissue BT is supported on the sample support 2; an image of the tissue BT is captured by an imager through infrared light irradiation; the calibration reference 5 for calibrating the imager and/or the sample support 2 is moved to switch between the disposed state in which the calibration reference 5 is disposed in the detection range of the imager (for example, in the field of view), and the withdrawn state in which the calibration reference 5 is disposed outside the detection range of the imager (for example, outside the field of view).

FIG. 15 is a flowchart for describing the operation example of the imaging system 1 and the imaging apparatus 10 according to the embodiment. The controller 7 performs the process of each step in accordance with an instruction command or information from the control apparatus 101. Accordingly, the subject of the operation may be considered the control apparatus 101.

(i) Step 101

The imaging system 1, prior to imaging the tissue BT using visible light or infrared light, for example, performs calibration of the first imager 21 (for example, a pixel value reference is calibrated on a pixel by pixel basis). In step 101, the controller 7 controls the switcher 6 to move the sample support 2 and cause the calibration reference 5 to be disposed in the detection range A1 of the first imager 21.

(ii) Step 102

The controller 7, in a state in which the door member 44 of the container 8 is disposed in the closed position, causes the infrared light sources 11 to irradiate the calibration reference 5 with infrared light of a plurality (for example, two) wavelengths simultaneously, and causes the first imager 21 to image the calibration reference 5. In this way, a standard white image (white image) of the calibration reference 5 is acquired.

The captured image (for example, the standard white image) obtained in step 102 is used to obtain an output of each pixel of the first imager 21 for example, a pixel value) with respect to a predetermined optical intensity. For example, the calibration reference 5 is formed such that the variation (dispersion) in spatial distribution (in-plane distribution) of reflectance is less than or equal to a predetermined value. For example, in the result (captured image) of detection performed by the detector (imaging unit 4), the distribution of detected values (for example, output pixel values) corresponds to the distribution of a characteristic (such as sensitivity, S/N ratio, or the relationship of output to optical intensity) of the light-receiving elements (the pixels of the imaging element 24). For example, the pixels of the imaging element 24 corresponding to a relatively dark portion in a captured image may have a low sensitivity compared to the other pixels. Such pixels may be given a gain increase or a positive offset, for example, to have their outputs with respect to a predetermined optical intensity aligned with those of the other pixels. The calibration reference 5 is also formed such that, for example, the distribution of reflectance in a predetermined wavelength band (the distribution of reflectance with respect to wavelength) becomes a predetermined distribution. For example, the distribution of detected values (for example, output pixel values) in the result (captured image) of detection performed by the detector (imaging unit 4) and the distribution of reflectance of the calibration reference 5 with respect to wavelength are compared with each other to obtain the characteristic (for example, sensitivity) of the light-receiving elements (the pixels of the imaging element 24) with respect to wavelength. For example, based on the wavelength dependency of the characteristic of the light-receiving elements obtained on the basis of a captured image (for example, the standard white image), it is possible to correct (calibrate) the characteristic of the light-receiving elements with respect to a predetermined wavelength.

(iii) Step 103

The controller 7 causes the door member 44 of the container 8 to be disposed in the closed position, and, in a state in which irradiation of infrared light from the infrared light sources 11 (infrared light of a plurality of wavelengths) is stopped, causes the first imager 21 to image the calibration reference 5. Then, the first imager 21 acquires a standard black image (dark image) of the calibration reference 5. The captured image (dark image) obtained in step 103 is used to obtain the output of each pixel (for example, a pixel value) of the first imager 21 when the optical intensity is substantially zero is obtained. For example, the pixels of the imaging element 24 corresponding to a relatively bright portion in the captured image may have lower sensitivity or more noise than the other pixels. Such pixels may be given a gain decrease or a negative offset to make their outputs with respect to a predetermined optical intensity (for example, optical intensity of substantially zero) aligned with those of the other pixels.

(iv) Step 104

The controller 7, using the captured image (for example, the standard white image) of step 102 and the captured image (for example, the standard black image) of step 103, calibrates the first imager 21 (for example, the pixel values output from the first imager 21) (calibration process: preprocessing with respect to a sample image generation process). Alternatively, the imaging system 1 (imaging apparatus 10) may calibrate the second imager 22 by performing the processes of step 101 to step 104 using the visible light sources 13 instead of the infrared light sources 11 and the second imager 22 instead of the first imager 21.

(v) Step 105

Then, the imaging system 1 (imaging apparatus 10), using the first imager 21 that has been calibrated, images the sample (tissue BT) through the processes of step 105 and thereafter. In step 105, the controller 7 controls the switcher 6 to cause the sample support 2 to be disposed in the detection range A1 of the first imager 21.

(vi) Step 106

The controller 7 senses that the biological tissue BT is disposed on the sample support 2. For example, the controller 7 automatically senses that the tissue BT has been disposed, using a sensor provided in the sample support 2. Alternatively, the controller 7 may sense a detection signal indicating that an imaging start button has been depressed by the user (operator) after the tissue BT was placed on the sample support 2.

(vii) Step 107

For example, the controller 7 reads, from a memory (not illustrated) of the imaging system 1 or the imaging apparatus 10, information about the wavelength of the infrared light for irradiation (wavelength information) and information about the optical intensity of each wavelength (optical intensity information) that the user has input via a graphical user interface (GUI) having a configuration as described below.

(viii) Step 108

The controller 7, for example, in a state in which the door member 44 of the container 8 is disposed in the closed position, causes the infrared light sources 11 to irradiate the tissue BT on the sample support 2 with infrared light of two wavelengths simultaneously, and causes the first imager 21 to detect infrared light that has passed through the tissue BT to image the tissue BT. The controller 7, based on the result of detection (imaging result) performed by the first imager 21, generates an image of the tissue BT (grayscale image).

Meanwhile, the user (operator) may designate a region for simultaneous irradiation with infrared light of a plurality of wavelengths (infrared light of mutually different wavelengths), and then an image of the region may be captured. For example, the controller 7 causes the tissue BT to be irradiated with visible light from the visible light sources 13, first-wavelength infrared light from the infrared light sources 11, or second-wavelength infrared light from the infrared light sources 11, and acquires an image (single-light irradiation image) captured by the first imager 21 or the second imager 22 through irradiation of the tissue BT with single light. The operator, looking at the single-light irradiation image being displayed on the display apparatus 103 or another display apparatus, designates a region in the tissue BT for simultaneous irradiation with infrared light of a plurality of wavelengths, using the input apparatus 102. The controller 7 receives the designation of the region made through the operator input, controls the infrared light sources 11 to cause the region designated in the single-light irradiation image to be irradiated with infrared light of a plurality of wavelengths (for example, first-wavelength infrared light and second-wavelength infrared light having a wavelength different from the first wavelength) simultaneously, and generates a grayscale image of the tissue BT based on the imaging result that has been obtained by the simultaneous irradiation.

(ix) Step 109

The controller 7 outputs data of the captured image (for example, the grayscale image) obtained in step 108 externally (for example, to the display apparatus 103 or a printer). The external output may include displaying on a screen of the display apparatus.

The controller 7 may perform the calibration process of step 101 to step 104 for each imaging operation, or for a predetermined number of times of imaging operation. The calibration process may be performed when a condition of imaging (detection) (for example, the shutter speed of the imaging element 24, the size of the detection range A1, the wavelength of the infrared light, infrared light intensity, and/or the amount of luminance or light) has been changed. The calibration process may be performed each time the imaging apparatus 10 is turned on (for each starting-up), or each time the imaging apparatus 10 has been started up a predetermined number of times. The calibration process may be performed each time a predetermined period has elapsed, or the calibration process may be performed based on a user command. The controller 7 may notify another apparatus (for example, the display apparatus 103) or the user about the recommended timing for performing the calibration process, based on the number of times of imaging that has been performed or the time that has elapsed since the previous calibration process, or an imaging condition.

<GUI for Setting Wavelength and Amount of Light>

FIG. 16 illustrates a configuration example of a graphical user interface (GUI) 1600 which is used when setting and adjusting the wavelength value and the amount of light of the infrared light with which the sample is irradiated. While in the present example the GUI is configured for setting two wavelengths, a similar configuration may be employed when three or more wavelengths are used.

For example, if the operator, using the input apparatus 102, has entered an instruction for infrared light simultaneous irradiation, the control apparatus 101 causes the GUI 1600 to be displayed on the display screen of the display apparatus 103. Then, the screen of the GUI 1600 being displayed on the display apparatus 103 can be operated (for example, to move the focus, switch the screen display, or input data), using an input apparatus, such as the input apparatus 102.

The GUI 1600 for setting two wavelengths, for example, includes configuration items including: a first-wavelength optical intensity setting box 1601 which is used when setting the optical intensity of infrared light of a first wavelength; a second-wavelength optical intensity setting box 1402 which is used when setting the optical intensity of infrared light of a second-wavelength; a first-wavelength selection box 1603 which is used when determining the wavelength value of the first wavelength; a second-wavelength selection box 1604 which is used when determining the wavelength value of the second wavelength; a save button 1605 which is used when saving setting contents in memory (not illustrated); and a close button 1606 which is used when closing the display of the GUI 1600.

In the first-wavelength optical intensity setting box 1601, for example, the numerical value of a ratio to the maximum output of the light source that outputs the first-wavelength infrared light (the ratio may be herein referred to as optical intensity) is input. In the second-wavelength optical intensity setting box 1601, for example, the numerical value of a ratio (%) to the maximum output of the light source that outputs the second-wavelength light is input. As an example, the amount of light of the second-wavelength light is fixed at 70% of the maximum output (maximum optical intensity), and the optical intensity of the first-wavelength light is made variable. In the illustrated example, the fixed optical intensity value is 70%. However, because the maximum output of the light source may change depending on the light source, the fixed optical intensity may be set to an arbitrary value, such as 20%, 65%, or 80%, for example.

In each of the first-wavelength selection box 1603 and the second-wavelength. selection box 1604, one of six wavelengths can be selected. However, the number of the wavelengths for selection is not limited to six. While the same wavelengths are available for the first wavelength and the second wavelength, the wavelengths for the first wavelength and the second wavelength may include different wavelengths, or the wavelengths available for selection may be totally different between them. For example, the GUI 1600 may be configured such that if 1070 nm has been selected for the first wavelength, 1070 nm cannot be selected for the second wavelength. The example of the GUI illustrated in FIG. 16 is configured such that the first wavelength and the second wavelength are selected from prepared groups of wavelengths. However, the GUI may be configured to allow the user to enter the value of the first wavelength and the value of the second wavelength directly, using the input apparatus 102.

For example, when the selection of the first wavelength and the second wavelength and the setting of the optical intensity of each wavelength have been completed, and an instruction for simultaneous irradiation with infrared light of two wavelengths has been entered (for example, when the operator has selected each wavelength, input the optical intensity values, depressed the save button 1605, and entered an instruction for starting simultaneous irradiation with two wavelengths), the control apparatus 102 reads, from the memory not illustrated, the setting values that have been saved of the optical intensity of the infrared light of each wavelength, and transmits the values of the optical intensity of the infrared light of each wavelength to the controller 7 of the imaging apparatus 10. The controller 7 receives from the control apparatus 101 the values of the optical intensity of the infrared light of each wavelength, and, for example, changes the voltage values to be applied to the infrared light sources, among the plurality of light sources 16 of the infrared light sources 11, corresponding to the selected wavelengths. Then, the infrared light sources corresponding to the respective wavelengths output infrared light with the voltage values that have been set. In this way, the sample (tissue BT) is irradiated with infrared light of an optical intensity that has been set.

The GUI 1600 in the illustrated example is configured such that optical intensity (unit: candela) is set or charged. However, because the amount of light changes when optical intensity is changed, the GUI 1600 may be configured such that the value of the amount of light (unit: lumen or lux) is set or changed. Herein, the optical intensity means the incident luminous flux of light per unit area, and the amount of light means a total of luminous flux in a certain period of time.

In the present embodiment, as illustrated in FIG. 16, the user (operator), using the GUI, inputs information about the amount of light (the value of amount of light, or the ratio of amount of light). However, the imaging system 1 may include a communication apparatus (not illustrated) to receive information about the amount of light that has been transmitted from an external device, or may read information about the amount of light stored in a semiconductor memory, such as a USB. In this way, the amount of light of the infrared light of each wavelength is set.

As described above, in the present embodiment, the infrared light intensity of each wavelength is adjusted, and the sample is irradiated with infrared light of a plurality of wavelengths simultaneously. In this way, it becomes possible to generate a sample image with which a plurality of substances can be distinguished more easily.

<Application Examples>

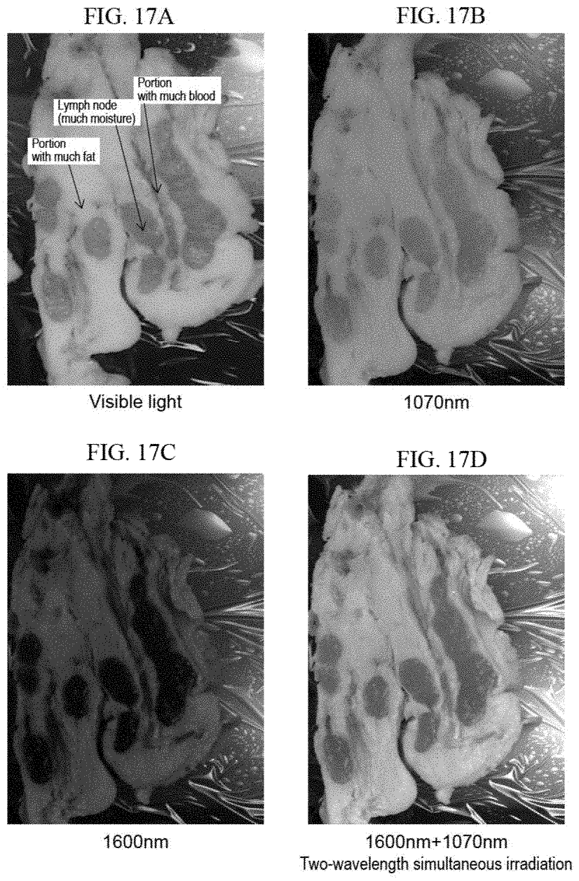

An application example of the two-wavelength photography in accordance with the present embodiment will be described. FIGS. 17A, 17B, 17C, and 17D show captured images of pig mesentery as a sample. FIG. 17A shows an image obtained by irradiating the pig mesentery with visible light. FIG. 17B shows an image obtained by irradiating the pig mesentery with infrared light of a wavelength of 1070 nm (for example, a first wavelength). FIG. 17C shows an image obtained by irradiating the pig mesentery with infrared light of a wavelength of 1600 nm (for example, a second wavelength). FIG. 17D shows an image obtained by simultaneously irradiating the pig mesentery with infrared light of two wavelengths of 1070 nm example, the first wavelength) and 1600 nm (for example, the second wavelength).

As illustrated in FIG. 17B, when the pig mesentery was only irradiated with infrared light of the first wavelength of 1070 nm, both lymph nodes with much water (moisture) and portions with much lipid were imaged brightly. However the image obtained was too bright and not necessarily easy to view. When the obtained image is too bright as a whole, it may become difficult to discriminate a lymph node and lipids clearly. Meanwhile, as illustrated in FIG. 17C, when the pig mesentery was only irradiated with infrared light of the second wavelength of 1600 nm, the lymph nodes with much water (moisture) were imaged darkly, and the portions with much lipid were imaged relatively brightly. In this case, too, the obtained image was dark as a whole and not necessarily easy to view. When the obtained image has low grayscale values as a whole, the image may enable discrimination of a lymph node and lipids but may not be easy to view. Accordingly, with the imaging apparatus 10 or the imaging system 1, the pig mesentery was irradiated with light of the first wavelength (in this case, 1070 nm) and light of the second wavelength (in this case, 1600 nm) simultaneously in accordance with the technique of the present embodiment. As a result, as illustrated in FIG. 17D, the grayscale values of the lymph nodes with much water (moisture) and the grayscale values of the portions with much lipid were raised (increased). Consequently, with the imaging apparatus 10 or the imaging system 1, the contrast between the lymph nodes and the portions at the peripheries thereof with much lipid became clear (the contrast ratio became higher), making it possible to obtain a clear image in which both the lymph nodes and the lipid portions are easy to view.

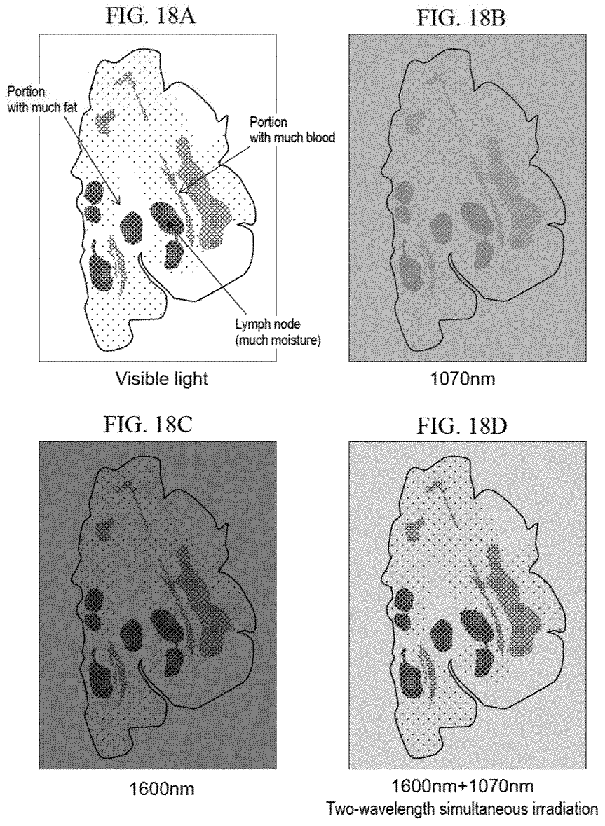

FIGS. 18A, 18B, 18C, and 18D show schematic drawings based on the images of FIGS. 17A, 17B, 17C, and 17D, depicted to facilitate an understanding of the images. FIGS. 18A, 18B, 18C, and 18D are similar to the images of FIGS. 17A, 17B, 17C, and 17D. Accordingly, description of FIGS. 18A, 18B, 18C, and 18D is omitted.

<Modifications of First Embodiment>

(1) First Modification

A first modification relates to a process for automatically setting the amount of light of each of a plurality of rays of infrared light with which the sample is irradiated. In the foregoing embodiment, the user (operator) inputs the amount of light of the irradiating infrared light. In the first modification, the imaging system 1 is configured to select and determine the amount of infrared light automatically from an acquired image.

FIG. 19 is a flowchart for describing a light amount adjustment process in the imaging system 1 according to the first modification. As an example, the optical intensity adjustment process of FIG. 19 according to the present embodiment is performed in step 107 of FIG. 15 described above.

For example, when the tissue BT is simultaneously irradiated with infrared light of a plurality of wavelengths (for example, infrared light of 1070 nm and infrared light of 1600 nm), the controller 7 or the control apparatus 101 performs the light amount adjustment process in which the infrared light of one wavelength (such as the infrared light with the wavelength of 1600 nm) is used as a reference with the amount of infrared light fixed in advance, and the amount of infrared light of the other wavelength (such as the infrared light of 1070 nm) is changed automatically on a step by step basis, for example. With regard to the infrared light of the wavelength of which the amount of light is fixed, the infrared light may be designated by the user, or the controller 7 or the control apparatus 101 may be configured to automatically select infrared light of a wavelength that provides an image in which the image brightness/darkness difference between a plurality of substances (for example, between water and oil (lipid), water and heavy water, or oil and heavy water) can be maximized. In the following, an automatic light amount adjustment process will be described with reference to the flowchart of FIG. 19.

(i) Step 201

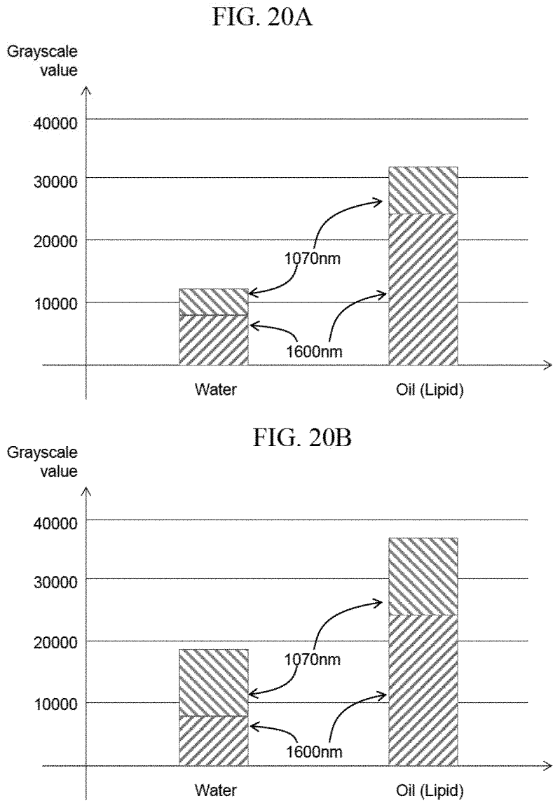

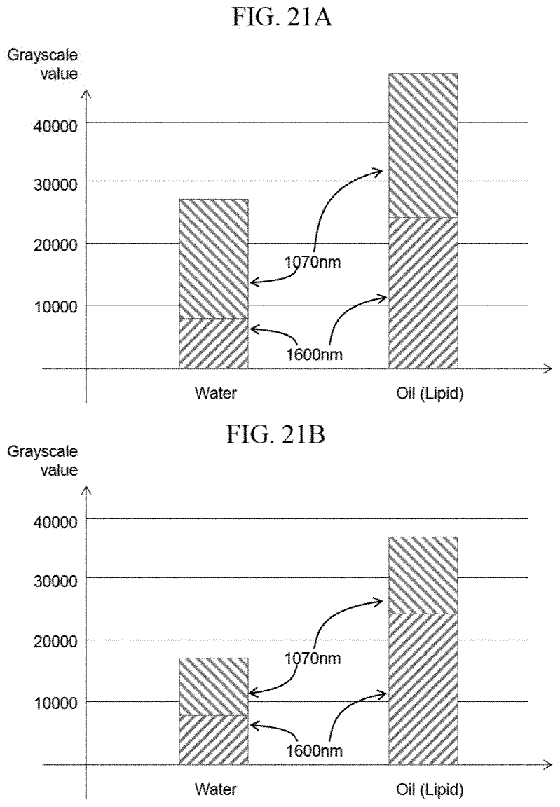

The controller 7 causes the tissue BT to be irradiated with infrared light of a wavelength (for example, a first wavelength) with a fixed optical intensity (first light: for example, infrared light with the wavelength of 1600 nm) and infrared light of a wavelength (for example, a second wavelength) with a variable optical intensity (the initial value of the intensity of the second-wavelength light is set in advance). Then, the controller 7 acquires the pixel values (grayscale values) of a most brightly captured portion (or a portion having pixel values close to those thereof) and the pixel values (grayscale values) of a most darkly captured portion (or a portion having pixel values close to those thereof) of the tissue BT. An example of increasing pixel values (grayscale values) will be described with reference to FIGS. 20A and 20B. In the case of an initial setting (FIG. 20A), the pixel values (grayscale values) acquired at this point in time are approximately 11500 for the darkest portion (for example, a portion with much water (moisture)) and approximately 31500 for the brightest portion (for example, a portion having much lipid). In this case, it is seen clearly that the intensity of the infrared light of the second wavelength (1070 nm, for example) is weak. An example of decreasing pixel values (grayscale values) will be described with reference to FIGS. 21A and 21B. In the case of an initial setting (FIG. 21A), the pixel values (grayscale values) acquired at this point in time are approximately 27500 fix the darkest portion (for example, a portion with much water (moisture)), and approximately 47500 for the brightest portion (for example, a portion having much lipid). In this case, it is seen clearly that the intensity of the infrared light of the second wavelength (1070 nm, for example) is too strong.

(ii) Step 202

The controller 7 determines whether the pixel values (grayscale values) of the most darkly captured portion acquired in step 201 are in a range of P % to (P+α) % of the pixel values (grayscale values) of the most brightly captured portion. It is desirable to increase the pixel values (grayscale values) of the most darkly captured portion to around the center of the pixel values (grayscale values) of the most brightly captured portion. Accordingly, the value of P is set to 50, for example. The value of a may be set to an arbitrary numerical value in an allowable range. If the pixel values (grayscale values) of the most darkly captured portion are in the range of P % to (P+α) % of the pixel values (grayscale values) of the most brightly captured portion (Yes in step 202), the process proceeds to step 203. If the pixel values (grayscale values) of the most darkly captured portion are not in the range of P % to (P+α) % of the pixel values (grayscale values) of the most brightly captured portion (No in step 202), the process proceeds to step 204.

(iii) Step 203

When the pixel values (grayscale values) of the most daddy captured portion are in the range of P % to (P+α) % of the pixel values (grayscale values) of the most brightly captured portion, it is possible to discriminate substances in the tissue BT satisfactorily. Thus, the controller 7 stores information about the optical intensity of the infrared light of each wavelength in a memory (not illustrated). The information about the intensity determined as described above is used in the process of step 108 in FIG. 15, together with information about each of the selected wavelengths of the infrared light.

(iv) Step 204

The controller 7 adjusts the optical intensity of the infrared light (second light: infrared light of 1070 nm, for example) of the wavelength (for example, a second wavelength) set for the variable optical intensity, by a predetermined amount (for example, k % of the maximum optical intensity that can be output). The initial value of the optical intensity of the infrared light of the wavelength set for the variable optical intensity may be set, as appropriate, and may be zero.

For example, if the pixel values (grayscale values) of the most darkly captured portion are lower than P % to (P+α) % of the pixel values (grayscale values) of the most brightly captured portion (see FIG. 20A), the controller 7 increases the optical intensity of the infrared light of the second wavelength (1070 nm, for example) by k %, for example. In this case, as illustrated by the change from FIG. 20A to FIG. 20B, the pixel values (grayscale values) of the most darkly captured portion and the pixel values (grayscale values) of the most brightly captured portion are both raised (increased) as a whole. The process of raising (increasing) the pixel values (grayscale values) is performed at least once to thereby bring the pixel values of the most darkly captured portion to within the range of P % to (P+α) % of the pixel values of the most brightly captured portion.

On the other hand, for example, if the pixel values (grayscale values) of the most darkly captured portion are greater than P % to (P+α) % of the pixel values (grayscale values) of the most brightly captured portion (see FIG. 21), the controller 7 decreases the optical intensity of the infrared light of the second wavelength (1070 nm, for example) by k %, for example. In this case, as illustrated by the change from FIG. 21A to FIG. 21B, the pixel values (grayscale values) of the most darkly captured portion and the pixel values (grayscale values) of the most brightly captured portion are both decreased as a whole. The process of decreasing the pixel values (grayscale values) is performed at least once to thereby bring the pixel values of the most darkly captured portion within the range of P % to (P+α) % of the pixel values of the most brightly captured portion.

When the pixel values (grayscale values) of the most darkly captured portion are in the range of P % to (P+α) % of the pixel values (grayscale values) of the most brightly captured portion, as described with reference to the process of step 203, the controller 7 stores information about the optical intensity of the infrared light of each wavelength in a memory (not illustrated) (step 204→step 202→step 203). The information about the intensity determined as described above is used in the process of step 108 of FIG. 15, together with the information about each of the selected wavelengths of the infrared light.

With reference to FIG. 19, it has been described that the pixel values (grayscale values) are raised (increased) or decreased by adjusting optical intensity. Alternatively, the amount of light may be adjusted, instead of optical intensity.

(2) Second Modification

The wavelengths of the plurality of infrared light rays for simultaneous irradiation and the values of optical intensity may differ depending on the property (for example, the type of site) of the sample (for example, tissues for irradiation). Thus, the imaging system 1 may be provided in advance with a table (stored in a storage device, such as a memory, as information) of a database for storing combinations (which may be referred to as optical intensity information), for each type of site, of the values of wavelengths to be used and the intensity of light of each wavelength. Then, the imaging system 1 may receive from the user a designation (input) of a site to be imaged, and then read and use a combination (optical intensity information), corresponding to the designated imaging site, of the values of the wavelengths of a plurality of infrared light rays and optical intensity values.

The imaging system 1 is a system including, for example, a display apparatus and an image processing apparatus (control apparatus). The image processing apparatus (control apparatus), for example, generates an image by subjecting an image of the tissue BT captured by the imaging system 1 to image processing. The imaging system 1 causes the display apparatus to display the captured image of the tissue BT and/or the image generated by the image processing apparatus. For example, the imaging system 1 of the present embodiment is utilizable in pathological diagnosis assistance medical equipment using infrared light (for example, a pathological imaging apparatus using infrared light).

(3) Third Modification

In the present embodiment, for example, the imaging apparatus 10 has the infrared light sources 11 including a plurality of infrared light sources for outputting infrared light of each wavelength, and light of each wavelength is output from the independent light sources. However, another embodiment may be employed. For example, a light source (such as a halogen lamp) that outputs light having a wide wavelength band ranging from short wavelengths to long wavelengths is used, the light output from the light source is separated into a plurality of light rays using an optical system, and the light rays are supplied to optical filters (including, for example, a filter that only passes light corresponding to the first wavelength, such as infrared light of 1070 nm, and a filter that only passes light corresponding to the second wavelength, such as infrared light of 1600 nm) to generate light of a plurality of wavelengths. The optical filters may be disposed in an optical path in the imaging apparatus 10 so as to be detachable by the controller 7.

### B. Second Embodiment

A second embodiment discloses an example in which the imaging system 1 of the first embodiment is applied in a surgery assistance system. Elements designated with reference numerals identical to those used with reference to the imaging system 1 of the first embodiment have identical configurations or functions. Accordingly, in the following, description of such configurations is simplified, as appropriate.

<Configuration of Surgery Assistance System>

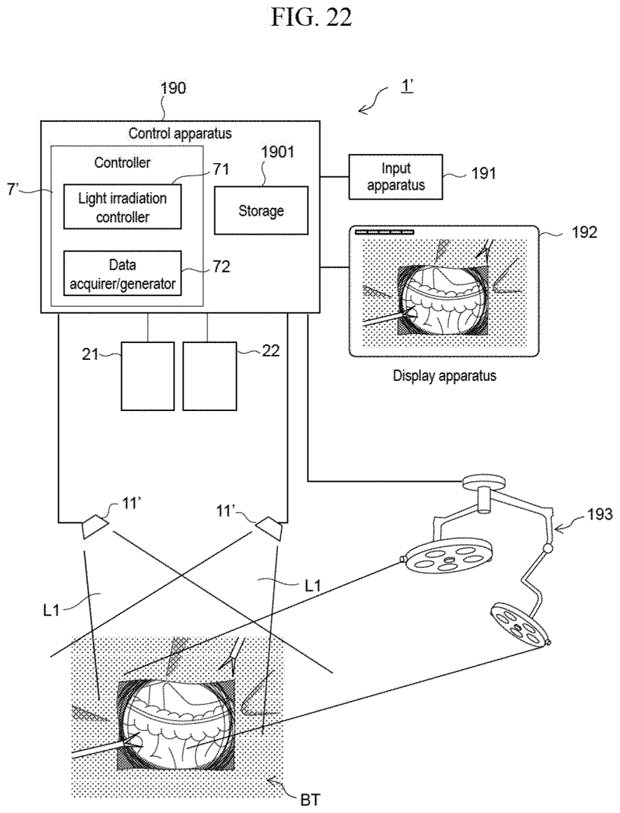

FIG. 22 illustrates a configuration example of a surgery assistance system 1′ according to the second embodiment.

The surgery assistance system 1′ includes: a control apparatus 190; an input apparatus 191; a display apparatus 192; a shadowless lamp 193; infrared light sources 11′; a first imager 21; and a second imager 22.

The control apparatus 190 is configured from a computer, for example, and includes a controller 7′ and a storage 1901. The controller 7′ has a configuration equivalent to that of the controller 7 of the first embodiment, and includes, for example: a light irradiation controller 71 which controls irradiation of the tissue BT with infrared light from the infrared light sources 11′ and irradiation of the tissue BT with visible light from the shadowless lamp 193; and a data acquirer/generator 72 which acquires imaging data from the first imager 21 and the second imager 22, and generates display data. The storage 1901 stores programs corresponding to the light irradiation controller 71 and the data acquirer/generator 72, various setting data input by the user (operator) via the input apparatus 191, various parameters and the like. Examples of the setting data input by the operator include the information, described with reference to the first embodiment, about the wavelengths of the plurality of infrared light rays for simultaneous irradiation of the tissue BT, and the information about the optical intensity of each infrared light ray.

The input apparatus 191 is an apparatus for inputting data, information, setting content instructions and the like to the control apparatus 190, and includes, for example, a keyboard, a mouse, and a microphone.

The first imager (first image sensor) 21 is an indium gallium arsenide (InGaAs) camera, for example, having a high sensitivity, in the wavelength band of infrared light, and detects light radiated from the tissue BT due to infrared light irradiation (examples of the radiated light include reflected light, scattered light, transmitted light, and reflected/scattered light). The second imager (second image sensor) 22 is a silicon (Si) camera, for example, having a high sensitivity in the wavelength band of visible light, and detects light radiated from the tissue BT due to irradiation of the tissue BT with visible light emitted from the shadowless lamp 193. The first imager 21 and the second imager 22 have their imaging fields of view adjusted to be able to detect the tissue BT during a surgery, for example. In the optical path between the first imager 21 and the tissue BT, and in the optical path between the second imager 22 and the tissue BT, mirrors, half-mirrors, dichroic minors and the like may be installed, and the optical axis of the first imager 21 and the optical axis of the second imager 22 may be set to be identical.

The infrared light sources 11′ have a configuration obtained by removing the visible light sources 13 from the illumination units 3 according to the first embodiment, for example. The visible light sources included in the infrared light sources 11 correspond to the shadowless lamp 193. The shadowless lamp 193 may be configured from a light source that does not emit light of wavelengths of the infrared light region, for example. For example, the shadowless lamp 193 is configured from LEDs for the colors of R, G, and B. While it is possible to use a halogen light source for the shadowless lamp 193, the halogen light source emits light of wavelengths of the infrared light region. Accordingly, when a halogen shadowless lamp is used, it is necessary to select the wavelength of the infrared light and to adjust the optical intensity setting so as not to influence the imaging operation by simultaneous irradiation with infrared light of a plurality of wavelengths.

The controller 7′, using the data acquirer/generator 72, acquires imaging data acquired by the first imager 21 and/or the second imager 22, and generates an image (for example, a real-time or non-real-time stationary image and moving image) to be displayed on the display apparatus 192. The controller 7′ may generate display data for displaying only the image captured by the first imager 21 on the display screen, or may generate display data for displaying an image captured by the first imager 21 and an image captured by the second imager 22 in parallel on the display screen (in dual-screen display, for example). The controller 7′ may generate display data for displaying on the display screen the image captured by the first imager 21 superimposed over the image captured by the second imager 22.

The display apparatus 192, for example, receives the generated display data from the control apparatus 190, and displays an image (for example, a video during a surgery) on the display screen.

In the surgery assistance system 1′ according to the second embodiment, the calibration process for the first imager 21 that is performed in the imaging, system 1 according to the first embodiment may be performed periodically during inspection, for example, and need not be performed each time an image is captured, as in the first embodiment.

<Operation of Surgery Assistance System>

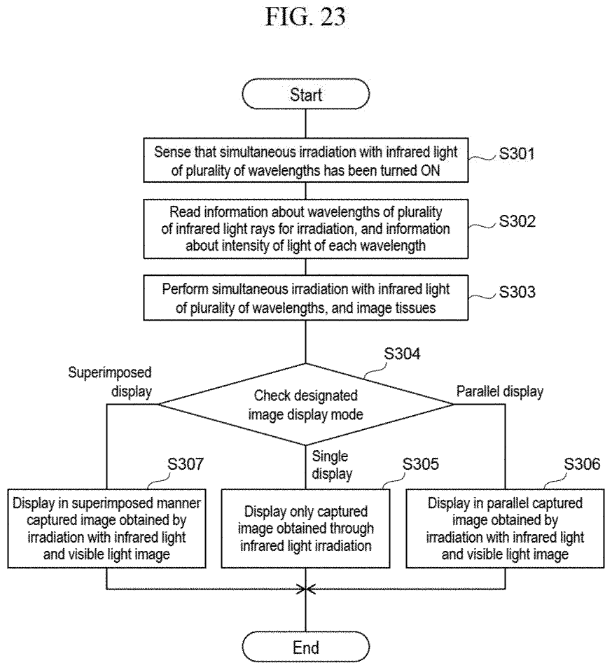

FIG. 23 is a flowchart for describing an operation example of the surgery assistance system 1′ according to the second embodiment.

(i) Step 301

For example, when a patient has been set on the operating table, and the function for simultaneous irradiation with infrared light of a plurality of wavelengths in the present embodiment has been turned ON by the operator at an appropriate timing (simultaneously with the start of surgery, or after the start of surgery), the controller 7′ senses that the function has been turned ON. If the function is not turned ON, the surgery is conducted only using the shadowless lamp 193 as usual.

(ii) Step 302

The controller 7′ reads from the storage 1901 the information about the wavelength of the infrared light for irradiation and the information about the optical intensity of each wavelength that have been input by the operator via the graphical user interface (GUI) illustrated in FIG. 16, for example.

When, for example, the wavelength of the infrared light and the optical intensity are automatically set, the process of FIG. 19 is performed in step 302. Also, when, for example, the surgery assistance system 1′ has in the storage 1601 the table of a database for storing the combinations (optical intensity information) for each type of surgery site, the values of the wavelengths used and the optical intensity of light of each wavelength, the surgery assistance system 1′ may receive designation (input) of a site to be imaged from the operator, and then read and use the combination (optical intensity information), corresponding to the designated imaging site, of the values of the wavelengths of a plurality of infrared light rays and the values of optical intensity.

(iii) Step 303

The controller 7′, with the shadowless lamp 193 being lighted, for example, causes the infrared light sources 11′ to irradiate the tissue BT with infrared light of a plurality (fur example, two) of wavelengths simultaneously, and causes the first imager 21 to capture an infrared light image of the tissue BT. Further, the controller 7′ causes the shadowless lamp 193 to irradiate the tissue BT with visible light, and causes the second imager 22 to capture a visible light image of the tissue BT.

(iv) Step 304

The controller 7′ determines what display mode for an image has been designated by the operator using the input apparatus 191, for example. In the second embodiment, for example, the display modes include: a mode (single display) for only displaying an image obtained through simultaneous irradiation with infrared light of a plurality of wavelengths; a mode (parallel display) for displaying an image obtained through simultaneous irradiation with infrared light of a plurality of wavelengths and an image obtained through visible light irradiation in parallel; and a mode (superimposed display) for displaying an image obtained through simultaneous irradiation with infrared light of a plurality of wavelengths and an image obtained through visible light irradiation in a superimposed manner. Display modes other than the three display modes may be designated for the controller 7′.

For example, if the independent display has been designated by the operator, the process proceeds to step 305. If the parallel display has been designated by the operator, the process proceeds to step 306. If the superimposed display has been designated by the operator, the process proceeds to step 307.

(v) Step 305

The controller 7′ controls the display apparatus 192 to display only the image captured by the first imager 21 through simultaneous irradiation of the tissue BT with infrared light of a plurality of wavelengths, on the screen of the display apparatus 192. The display apparatus 192 receives from the control apparatus 190 image data obtained by the first imager 21 through simultaneous irradiation of the tissue BT with infrared light of a plurality of wavelengths, and displays an image of the image data received on the screen.

(vi) Step 306

The controller 7′ controls the display apparatus 192 to display the image captured by the first imager 21 through simultaneous irradiation of the tissue BT with infrared light of a plurality of wavelengths, and the image captured by the second imager 22 by irradiating the tissue BT with visible light, in parallel on the screen of the display apparatus 192. The display apparatus 192 receives from the control apparatus 190 parallel display data of the image captured by the first imager 21 through simultaneous irradiation of the tissue BT with infrared light of a plurality of wavelengths and the image captured by the second imager 22 by irradiating the tissue BT with visible light, and displays on the screen the images of the parallel display data that have been received.

(vi) Step 307

The controller 7′ controls the display apparatus 192 to display the image captured by the first imager 21 through simultaneous irradiation of the tissue BT with infrared light of a plurality of wavelengths, and the image captured by the second imager 22 by irradiating the tissue BT with visible light, in a superimposed manner on the screen of the display apparatus 192. The display apparatus 192 receives from the control apparatus 190 the superimposed display data of the image captured by the first imager 21 through simultaneous irradiation of the tissue BT with infrared light of a plurality of wavelengths and the image captured by the second imager 22 by irradiating the tissue BT with visible light, and displays the images of the superimposed display data that have been received on the screen.

### C. Other Embodiments

(i) The present embodiment discloses the imaging system in which a sample is irradiated with light to acquire an image of the sample, and the image is displayed on a display screen. The imaging system includes: a light source (for example, the infrared light sources 11) Which outputs at least first-wavelength light and second-wavelength light different from the first wavelength; a light detector (for example, the first imager 21) which detects light radiated from the sample being irradiated with the light from the light source; a control apparatus (for example, the controller 7) which control the light source to irradiate the sample with light, and controls the light detector to generate an image of the sample; and a display apparatus (for example, the display apparatus 103) which displays the generated image. The control apparatus controls the light source to irradiate the sample with the first-wavelength light and the second-wavelength light simultaneously while adjusting the intensity of the first-wavelength light and the second-wavelength light, and generates an image of the sample by detecting, using the light detector, the light radiated from the sample due to the simultaneous irradiation. The light source outputs light of at least two wavelengths in the infrared light wavelength region, for example.

The sample includes a first site (for example, a first-type site containing water (moisture) more than any other substances) and a second site (for example, a second-type site containing a lipid more than any other substances). In this case, the image obtained by irradiating the sample with the second-wavelength light (for example, light of 1600 nm, 1450 nm, and 1200 nm) is brighter at the second site than at the first site. Meanwhile, the image obtained by irradiating the sample with the first-wavelength light (light of 970 nm and 1070 nm, for example) is as bright at the first site as at the second site.

(ii) In the present embodiment, for example, the controller 7 may include a light irradiation mode setting function (mode setter) for switching infrared light irradiation modes in response to an instruction (for example, an operator input) from the input apparatus 102. The infrared light irradiation modes include, for example: a mode (a first mode: a simultaneous irradiation mode) for irradiating the tissue BT (sample) with two or more infrared light rays having different wavelengths simultaneously; and a mode (a second mode: conventional irradiation) for (successively) irradiating the tissue BT (sample) with a single light ray (for example, first-wavelength light or visible light). The first mode includes a timing of irradiation of the tissue BT such that the two or more infrared light rays having different wavelengths impinge on the tissue BT (sample) simultaneously (or in an at least partially overlapping manner).
(iii) In the present embodiment, for example, there are two or more combinations of wavelengths of the infrared light for simultaneous irradiation. The controller 7 controls the light sources of the illumination units 3 so that the tissue BT (sample) is irradiated successively or alternately using a set of the combinations, and acquires the result of imaging performed using a plurality of wavelengths. The controller 7 may cause a plurality of acquired results to be displayed on the display screen of the display apparatus 103 simultaneously, and allow the operator to select an image.
(iv) In the present embodiment, the tissue BT (sample) is irradiated with two or more infrared light rays simultaneously, as described above. The irradiation with two or more infrared light rays may be performed so as to cover the entire tissue BT (sample), or in such a way that a specific region of the tissue BT (sample) (for example, a site of tumor or lymph node) is irradiated with two or more infrared light rays in a superimposed manner. When irradiation is performed with infrared light rays in a superimposed manner, the operator may determine (issue an instruction) the specific region for superimposition in advance.
(v) It is possible to achieve the functions of the present embodiment using a software program code. In this case, a storage medium having the program code recorded thereon is provided to the system or apparatus, and the program code stored in the storage medium is read by a computer (or a CPU or an MPU) in the system or apparatus. In this case, the functions of the embodiment are achieved by the program code per se that has been read from the storage medium, and the program code per se and the storage medium having the same stored therein constitute the present embodiment. Examples of the storage medium for supplying the program code include flexible discs, a CD-ROM, a DVD-ROM, hard disks, optical disks, magnetooptical disks, a CD-R, magnetic tapes, non-volatile memory cards, and a ROM.

Based on the instruction of the program code, a part or all of an actual process may be executed by an operating system (OS) and the like running on the computer, and the functions of the embodiment may be achieved by the process. After the program code read from the storage medium has been written to a memory on the computer, a part or all of an actual process may be executed by the CPU and the like of the computer based on the instruction of the program code, and the functions of the embodiment may be achieved by the process.

Further, the software program code for achieving the functions of the embodiment may be delivered via a network, and stored in a storage means, such as a hard disk or a memory in the system or device, or in a storage medium such as a CD-RW or a CD-R. The program code stored in the storage medium or the storage means may be then read and executed by the computer (or a CPU or MPU) of the system or device during use.

The processes and techniques described herein are not essentially associated with any specific apparatuses, and may be implemented using any appropriate combination of components. Further, various types of general-purpose devices are usable in accordance with the methods described herein. There may be cases in Which it is beneficial to construct a dedicated apparatus for performing the steps of the methods described herein. A plurality of constituent elements disclosed in the embodiments may be combined in an appropriate manner to form various inventions. For example, some constituent elements may be deleted from the constituent elements indicated in an embodiment. Constituent elements from different embodiments may be combined, as appropriate.

As will be apparent to those having ordinary skills in the relevant art, other implementations of the present invention are possible in view of the disclosure and embodiments described herein. Various modes and/or components of the embodiments described herein may be used either independently or in any combination.

### DESCRIPTION OF SYMBOLS

1 Imaging system
1′ Surgery assistance system
2 Sample support
3 Illumination unit
4 Imaging unit (detection unit)
5 Calibration reference
6 Switcher
7, 7′ Controller
8 Container
10 Imaging apparatus
11, 11′ Infrared light source
12 Holder
13 Visible light source
14 Light source mover
15 Diffuser
16 Plurality of light sources
21 First imager
22 Second imager
23 Imaging optical system (Detecting optical system)
24 Imaging element (Light-receiving element)
31 Size changer
32 Rotational axis
35 Stopper
36, 46 Actuator
40 Leg
41 Base
42 Frame
43 Cover
44 Door member
45 Door driver
47 Transmitter
48 Member
49 Contactless sensor
51, 52,53 Rotational axis
54 Optical member
55, 56 Roller
101, 190 Control apparatus
102, 191 Input apparatus
103, 192 Display apparatus
193 Shadowless lamp
A1 Detection range
BT Tissues

1. An imaging apparatus comprising:
a light detector configured to detect light radiated from a sample irradiated with first-wavelength infrared light and second-wavelength infrared light from a light source; and
a controller configured to adjust at least one of an intensity of the first-wavelength infrared light or an intensity of the second-wavelength infrared light, and configured to generate an image of the sample based on a detection result obtained by irradiating the sample with the first-wavelength infrared light and the second-wavelength infrared light simultaneously.

2. The imaging apparatus according to claim 1, wherein the first-wavelength light and the second-wavelength light include light having wavelengths of mutually different infrared light wavelength regions.

3. The imaging apparatus according to claim 1, wherein the controller is configured to cause the light source to output the second-wavelength infrared light with the intensity thereof adjusted relatively with respect to the first-wavelength infrared light.

4. The imaging apparatus of claim 1, wherein the controller is configured to control the light source to irradiate the sample with the first-wavelength infrared light and the second-wavelength infrared light simultaneously, the controller configured to adjust the first-wavelength infrared light and the second wave-length infrared light based on optical intensity information that has been set.

5. The imaging apparatus according to claim 4, wherein the controller is configured to control the light source such that the intensity of the first-wavelength infrared light and the intensity of the second-wavelength infrared light become an intensity of light based on the optical intensity information.

6. The imaging apparatus according to claim 4, wherein the controller includes a receiver configured to receive the optical intensity information.

7. The imaging apparatus according to claim 1, wherein the controller is configured to change a synthesis ratio of the first-wavelength infrared light and the second-wavelength infrared light based at least on an intensity of light for irradiating the sample.

8. The imaging apparatus according to claim 1, wherein the controller is configured to control the light source to irradiate the sample with the first-wavelength infrared light and the second-wavelength infrared light, and
wherein the first-wavelength infrared light and the second-wavelength infrared light are synthesized on the sample.

9. The imaging apparatus according to claim 1, wherein the controller is configured to control a first light source of the light source that outputs the first-wavelength infrared light and a second light source of the light source that outputs the second-wavelength infrared light so that the sample is irradiated with the first-wavelength infrared light and the second-wavelength infrared light simultaneously.

10. The imaging apparatus according to claim 1, wherein:
the first wavelength is a wavelength selected from a wavelength band in the range from 750 nm to 3000 nm; and
the second wavelength is a wavelength in a wavelength band in the range from 750 nm to 3000 nm and different from the first wavelength.

11. The imaging apparatus according to claim 1, wherein:
the first wavelength is a wavelength selected from a wavelength band in the range from 750 nm to 1100 nm; and
the second wavelength is a wavelength selected from a wavelength band in the range from 1400 nm to 1650 nm.

12. The imaging apparatus according to claim 1, wherein the controller is configured to control the light source to change a ratio between the intensity of the first-wavelength infrared light and the intensity of the second-wavelength infrared light in accordance with a type of the sample.

13. The imaging apparatus according to claim 1, wherein the controller is configured to control a light source of the first-wavelength infrared light and the second wave-length infrared light based on a value of the first wavelength and a value of the second wavelength that have been input via a user interface, and the intensity of the first-wavelength infrared light and the intensity of the second-wavelength infrared light based on input received via the user interface.

14. The imaging apparatus according to claim 1, wherein the controller is configured to determine the intensity of the first-wavelength infrared light and the intensity of the second-wavelength infrared light based on a pixel value in a bright image portion obtained by irradiating the sample with the second-wavelength infrared light, and a pixel value in a dark image portion obtained by irradiating the sample with the first-wavelength infrared light, and is configured to control the light source based on the determined intensities of light.

15. The imaging apparatus according to claim 1, wherein:
the sample includes a first site containing water more than a first lipid, and a second site containing more of the first lipid or a second lipid than water; and
an absorbance difference between the first site and the second site with respect to the first-wavelength infrared light is smaller than an absorbance difference between the first site and the second site with respect to the second-wavelength infrared light.

16. An imaging apparatus comprising:
a light detector configured to detect light radiated from a sample due to, while irradiating the sample with first-wavelength infrared light, irradiation of the sample with second-wavelength infrared light with an intensity thereof adjusted with respect to the first-wavelength infrared light; and
a controller configured to generate an image of the sample based on a detection result obtained by the light detector.

17. The imaging apparatus according to claim 16, wherein the controller, when irradiating the sample with light, is configured to adjust the intensity of the first-wavelength infrared light or the intensity of the second-wavelength infrared light.

18. The imaging apparatus according to claim 16, wherein the controller is configured to adjust the intensity of the first-wavelength infrared light and the intensity of the second-wavelength infrared light based on an absorbance of a substance included in the sample.

19. The imaging apparatus according to claim 16, wherein the controller is configured to adjust the intensity of the first-wavelength infrared light or the intensity of the second-wavelength infrared light based on a grayscale value of an acquired image of the sample.

20. The imaging apparatus according to claim 16, wherein:
the sample includes a water portion; and
the first-wavelength infrared light has a higher absorbance in the water than the second-wavelength infrared light.

21. The imaging apparatus according to claim 20, wherein:
the sample includes the water portion and a protein; and
the first-wavelength infrared light has a higher absorbance in the water than in the protein.

22. An imaging system comprising:
the imaging apparatus according to claim 1 to generate an image of the sample; and
a display apparatus configured to display the generated image.

23. The imaging system according to claim 22, wherein:
the light source includes a first light source configured to output the first-wavelength infrared light, and a second light source configured to output the second-wavelength infrared light; and
the controller is configured to control the first light source and the second light source to irradiate the sample with the first-wavelength infrared light and the second-wavelength infrared light simultaneously.

24. The imaging system according to claim 22, wherein the light source outputs light of a wavelength band including the first wavelength and the second wavelength,
the imaging system comprising an optical member configured to reflect or transmit the first-wavelength infrared light and the second-wavelength infrared light among the light of the wavelength band, to irradiate the sample with the first-wavelength infrared light and the second-wavelength infrared light.

25. The imaging system according to claim 22, wherein the controller is configured to control the light source to change a ratio between the intensity of the first-wavelength infrared light and the intensity of the second-wavelength infrared light in accordance with a type of the sample.

26. The imaging system according to claim 22, comprising a database configured to store, for each type of the sample, a combination of a wavelength to be used for the infrared light irradiation and an intensity of light of the wavelength.

27. The imaging system according to claim 22, wherein:
the light source includes a visible light source for outputting visible light; and
the controller is configured to control output of the first-wavelength infrared light, the second-wavelength infrared light, and the visible light.

28. The imaging system according to claim 22, comprising a housing containing the light source and the light detector,
wherein the housing includes a door member for opening and closing an opening enabling extraction of the sample mounted on a sample support, and a driver for driving the door member.

29. An imaging method comprising:
detecting, by a light detector, light radiated from a sample which is irradiated with first-wavelength infrared light and second-wavelength infrared light from a light source;
adjusting, by a control apparatus, an intensity of the first-wavelength infrared light or an intensity of the second-wavelength infrared light; and
generating an image of the sample based on a detection result obtained by irradiating the sample with the first-wavelength infrared light and the second-wavelength infrared light simultaneously.

30. The imaging method according to claim 29, wherein the first-wavelength infrared light and the second-wavelength infrared light are light having wavelengths of mutually different infrared light wavelength regions.

31. The imaging method according to claim 29, wherein:
the first wavelength is a wavelength selected from a wavelength band in the range from 750 nm to 1100 nm; and
the second wavelength is a wavelength selected from a wavelength band in the range from 1400 nm to 1650 nm.

32. The imaging method according to claim 29, further comprising:
causing, by the control apparatus, the first-wavelength infrared light and the second-wavelength infrared light to irradiate a calibration reference used for calibrating the light detector, thereby acquiring an image of the calibration reference; and
performing a process of calibrating the light detector.

33. The imaging method according to claim 29, further comprising:
irradiating the sample with single light by causing, by the control apparatus, the sample to be irradiated with visible light, the first-wavelength infrared light, or the second-wavelength infrared light;
acquiring a single-light irradiation image detected by the light detector;
controlling, by the control apparatus, the light source; and,
generating, with respect to a specified region in the single-light irradiation image, a grayscale image of the sample based on a detection result obtained by the light detector through simultaneous irradiation with the first-wavelength infrared light and the second-wavelength infrared light.

34. The imaging method according to claim 29, wherein:
the sample includes a first site and a second site; and
an image obtained through irradiation with the second-wavelength infrared light is brighter at the second site than at the first site, and an image obtained through irradiation with the first-wavelength infrared light is as bright at the first site as at the second site.

35. The imaging method according to claim 29, wherein:
the sample includes a first-type site containing water more than lipid, and a second-type site containing lipid more than water; and
an absorbance difference between the first-type site and the second-type site with respect to the first-wavelength infrared light is smaller than an absorbance difference between the first-type site and the second-type site with respect to the second-wavelength infrared light.

36. The imaging method according to claim 29, further comprising:
controlling, by the control apparatus, the light source to change a ratio between the intensity of the first-wavelength infrared light and the intensity of the second-wavelength infrared light in accordance with a type of the sample.

37. The imaging method according to claim 29, comprising:
acquiring, by the control apparatus, a first pixel value in a bright image portion obtained by irradiating the sample with the second-wavelength infrared light;
acquiring, by the control apparatus, a second pixel value in a dark image portion obtained by irradiating the sample with the first-wavelength infrared light;
determining, by the control apparatus based on the first pixel value and the second pixel value, the intensity of the first-wavelength infrared light and the intensity of the second-wavelength infrared light; and
controlling, by the control apparatus, the light source based on the determined intensities of light.
